(19) United States
(12) Patent Application Publication
(10) Pub. No.: US 2009/0314751 A1
(43) Pub. Date: Dec. 24, 2009

(54) LASER SCRIBE INSPECTION METHODS AND SYSTEMS

(75) Inventors: Antoine P. Manens, Sunnyvale, CA (US); Bassam Shamoun, Fremont, CA (US); Jeffrey S. Sullivan, Castro Vallley, CA (US); John White, Hayward, CA (US); Michael Shirk, Brentwood, CA (US)

Correspondence Address: TOWNSEND AND TOWNSEND AND CREW LLP, TWO EMBARCADERO CENTER, EIGHTH FLOOR, SAN FRANCISCO, CA, 94111-3834, US

(73) Assignee: Applied Materials, Inc., Santa Clara, CA (US)

(21) Appl. No.: 12/422,224

(22) Filed: Apr. 10, 2009

Related U.S. Application Data
(60) Provisional application No. 61/044,390, filed on Apr. 11, 2008.
(60) Provisional application No. 61/047,372, filed on Apr. 23, 2008.
(60) Provisional application No. 61/116,254, filed on Nov. 19, 2008.

(51) Int. Cl. B23K 26/00

(52) U.S. Cl. 219/121.69; 219/121.68

(57) ABSTRACT

Methods and systems for use during laser-scribing of a workpiece are provided. Some of the methods and systems provided use an imaging device to control the formation of a laser-scribed feature so as to more closely align with a previously-formed feature. Some of the methods and systems provided use an imaging device for inspection of a laser-scribed feature and/or process control. Some of the methods and systems provided use an imaging device to detect and avoid a workpiece defect during the formation of a laser-scribed feature.

### CROSS-REFERENCES TO RELATED APPLICATIONS

This application claims the benefit of U.S. Provisional Patent Application Nos. 61/044,390, filed Apr. 11, 2008, entitled “Dynamic Scribe Alignment for Laser Scribing, Welding or any Patterning System;” 61/047,372, filed Apr. 23, 2008, entitled “Laser Scribing Platform;” and 61/116,254, filed Nov. 19, 2008, entitled “Laser Scribe Inspection Methods and Systems,” the full disclosures of which are hereby incorporated herein by reference.

### BACKGROUND

Various embodiments described herein relate generally to laser scribing, welding, or patterning of materials, and more particularly to systems and methods for forming features positioned relative to previously-formed features on a workpiece. These systems and methods can be particularly effective for laser scribing thin-film single-junction and multi-junction solar cells.

Current methods for forming thin-film solar cells involve depositing or otherwise forming a plurality of layers on a substrate, such as a glass, metal or polymer substrate suitable to form one or more p-n junctions. An exemplary thin solar cell includes a transparent-conductive-oxide (TCO) layer, a plurality of doped and undoped silicon layers, and a metal back layer. A series of laser-scribed lines is typically used to create individual cells connected in series. Examples of materials that can be used to form solar cells, along with methods and apparatus for forming the cells, are described, for example, in co-pending U.S. patent application Ser. No. 11/671,988, filed Feb. 6, 2007, entitled “MULTI-JUNCTION SOLAR CELLS AND METHODS AND APPARATUSES FOR FORMING THE SAME,” which is hereby incorporated herein by reference. When a panel is being formed from a large substrate, a series of laser-scribed lines is typically used within each layer to delineate the individual cells. FIGS. 1A-1E illustrate one such method for forming thin-film solar cells using laser-scribed lines. FIG. 11A illustrates the first step in the formation of a thin-film solar cell, where a TCO layer 11 is deposited on a glass substrate 10. FIG. 1B illustrates the second step, where a first set of lines 12 (herein referred to as “P1” plurality of doped and undoped amorphous silicon (a-Si) layers 13 are deposited on top of the TCO layer 11 and within the scribed P1 lines 12. FIG. 1D illustrates the fourth step, where a second set of lines 14 (“P2” lines) are laser scribed in the silicon layers 13. FIG. 1E illustrates the fifth step, where a metal layer 15 is deposited on top of the silicon layers 13 and within the scribed P2 lines 14. FIG. 1E also illustrates the sixth step, where a third set of lines 16 (“P3” lines) are laser scribed.

To maximize the power output from a thin-film solar panel, it is important to minimize the surface area that is rendered, by the laser-scribing process, useless for power production. To do this, the three lines, so called P1, P2 and P3, need to be as close as possible to each other. Therefore, when scribing P2 lines it is therefore to form the P2 lines as close as possible to the existing P1 lines, and similarly for P3 lines relative to the P2 lines.

Accordingly, it is desirable to develop systems and methods that overcome at least some of these, as well as potentially other, deficiencies in existing scribing alignment, solar panel manufacturing, and other such devices. Further, it can also be seen that this need for better alignment or relative positioning between scribe lines or other features may also exist for welding or other patterning systems.

### BRIEF SUMMARY

Methods and systems in accordance with many embodiments provide for more accurate relative positioning or alignment between features formed on a workpiece, such as by laser scribing, welding, or patterning. These systems and methods can be particularly effective for laser scribing thin-film multi-junction solar cells.

Thus, the following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

In accordance with many embodiments, a method for using a laser-scribing device to laser scribe a workpiece having a first scribed feature is provided. The method comprises using an image-capture device to capture sequential images along the first feature, processing at least one of the images so as to determine a position of the first feature, and using the first feature position to control the formation of a second scribed feature at a controlled distance from the first feature. The formation of at least a part of the second feature is accomplished before the capture of at least one of the images.

In accordance many embodiments, a method for using a laser-scribing device to laser scribe a workpiece having a first scribed feature is provided. The method comprises forming a first length of a second scribed feature adjacent to the first feature, using an image-capture device to capture a first image that includes at least a portion of the first feature and at least a portion of the first length of the second feature, processing the first image so as to determine a first relative separation between the first feature and the second feature, and using the first relative separation to align output from the laser-scribing device in order to form a second length of the second feature within a smaller deviation from a controlled distance from the first feature than for the first length of the second feature.

In accordance with many embodiments, a system for laser scribing a workpiece having a first scribed feature and a partially-formed second scribed feature is provided. The system comprises a laser operable to generate output able to remove material from the workpiece, a scanning device operable to control a position of the output from the laser relative to the workpiece, an imaging device having a predetermined orientation relative to the scanning device, and a control device coupled with the scanning device and the imaging device. The imaging device is configured to capture an image between laser pulses and output image data in response thereto. The image includes at least a portion of the first feature and at least a portion of the second feature. The control device is adapted so as to process the image data so as to generate a positional correction for the formation of a subsequent portion of the second feature relative to the first feature.

In accordance with many embodiments, a method for patterning a workpiece is provided. The method comprises forming a first feature on a workpiece, forming a first portion of a second feature on the workpiece, generating position data for the first feature and the first portion of the second feature by using at least two regions in a viewable area of an imaging device, determining a separation distance between the first feature and the first portion of the second feature by using position data from at least one of the two regions, and forming a second portion of the second feature by using the separation distance to control a position of the second portion of the second feature relative to the first feature.

In accordance with many embodiments, a method for forming a laser-scribed line within a solar-cell assembly having a defect is provided. The method comprises using an imaging device to capture one or more images of the assembly, processing the one or more images to detect a defect of the assembly, and altering the formation path of the laser-scribed line to prevent the defect from interfering with the formation of the laser-scribed line.

In accordance with many embodiments, a system for laser scribing a solar-cell assembly having a defect is provided. The system comprises a laser operable to generate output able to remove material from the assembly, a scanning device operable to control a position of the output from the laser relative to the assembly, an imaging device for capturing one or more images of a portion of the assembly located in a projected formation path for a laser-scribed line and outputting image data in response thereto, and a processor coupled with the imaging device and the scanning device. The processor comprises a tangible medium comprising instructions that when executed cause the processor to process the image data to detect a defect of the assembly, and alter the formation path for the laser-scribed line to prevent the defect from interfering with the formation of the laser-scribed line.

For a fuller understanding of the nature and advantages of the present invention, reference should be made to the ensuing detailed description and accompanying drawings. Other aspects, objects and advantages of the invention will be apparent from the drawings and detailed description that follows.

### BRIEF DESCRIPTION OF THE DRAWINGS

FIG. 1A-1E illustrate a method for forming thin-film solar cells using laser-scribed lines, in accordance with many embodiments.

FIG. 2 illustrates a perspective view of a laser-scribing device that can be used in accordance with many embodiments.

FIG. 3 illustrates an end view of a laser-scribing device that can be used in accordance with many embodiments.

FIG. 4 illustrates components of a laser assembly that can be used in accordance with many embodiments.

FIG. 5 illustrates the generation of multiple scan areas that can be used in accordance with many embodiments.

FIG. 6 diagrammatically illustrates the integration of an imaging device with a laser-scanning assembly, in accordance with many embodiments.

FIG. 7 diagrammatically illustrates the use of camera tracking to locate and/or inspect a previously-formed laser-scribed line, in accordance with many embodiments.

FIG. 8 is a simplified block diagram illustrating a method for using leading camera tracking to laser scribe a workpiece having a first scribed feature, in accordance with many embodiments.

FIG. 9 diagrammatically illustrates the use of “on-the-fly” inspection and forward correction of laser-scribed line position, in accordance with many embodiments.

FIG. 10 is a simplified block diagram illustrating a method for using “on-the-fly” inspection and correction to laser scribe a workpiece having a first scribed feature, in accordance with many embodiments.

FIG. 11 diagrammatically illustrates the integration of a camera with a laser-scanning assembly, showing locations for photodiodes that can be used to measure laser-pulse reflections and illumination source locations, in accordance with many embodiments.

FIG. 12 diagrammatically illustrates a control scheme for scribe alignment, in accordance with many embodiments.

FIG. 13 diagrammatically illustrates a closed-loop control system for scribe alignment, in accordance with many embodiments.

FIG. 14 diagrammatically illustrates signals between components of a laser-scribing system, in accordance with many embodiments.

FIG. 15 diagrammatically illustrates components of a control system for scribe alignment, showing relative timing of laser-ablation pulses, photodiode timing, and illumination-strobe timing, in accordance with many embodiments.

FIG. 16 diagrammatically illustrates a closed-loop control system for scribe alignment, showing the use of a vision system to supply an indication of the current output position of a laser-scribing device, in accordance with many embodiments.

FIG. 17 illustrates an overview of the beam position of the laser-scribing device relative to a previously-scribed feature, in accordance with many embodiments.

FIG. 18 illustrates that the centroid values for laser-scribed lines disposed at assorted center-to-center and edge-to-edge spacing distances can be determined and used for scribe alignment, in accordance with many embodiments.

FIG. 19 diagrammatically illustrates the use of an imaging device to detect a workpiece defect in a projected path of a laser-scribed line, in accordance with many embodiments.

FIG. 20 illustrates a signal generated in response to an image of a laser-scribed line, and a signal generated in response to an image of a laser-scribed line and an adjacent workpiece defect, in accordance with many embodiments.

FIGS. 21A, 21B, and 21C diagrammatically illustrate imaging devices that can be used to detect a workpiece defect, in accordance with many embodiments.

FIG. 22 is a simplified block diagram illustrating a method for detecting and avoiding a workpiece defect during the formation of a laser-scribed line, in accordance with many embodiments.

FIG. 23 is a simplified block diagram illustrating a control system that can be used to detect and/or avoid a workpiece defect during laser-scribing, in accordance with many embodiments.

FIG. 24 illustrates laser-scribed lines and two workpiece defects, showing example scribed-line paths that can be used to avoid the workpiece defects, in accordance with many embodiments.

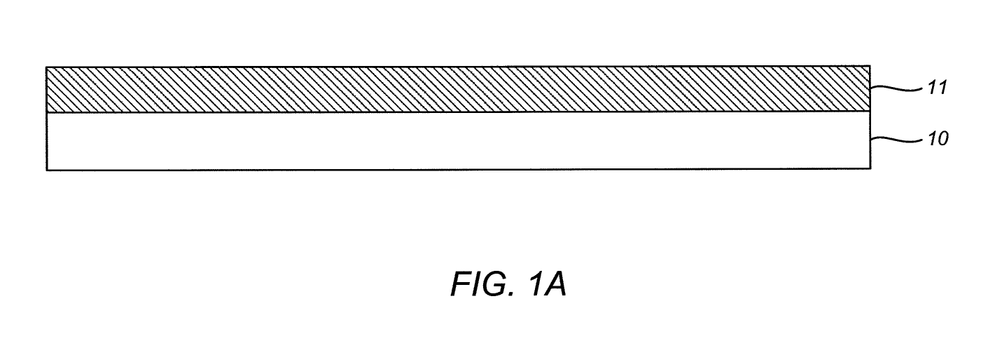

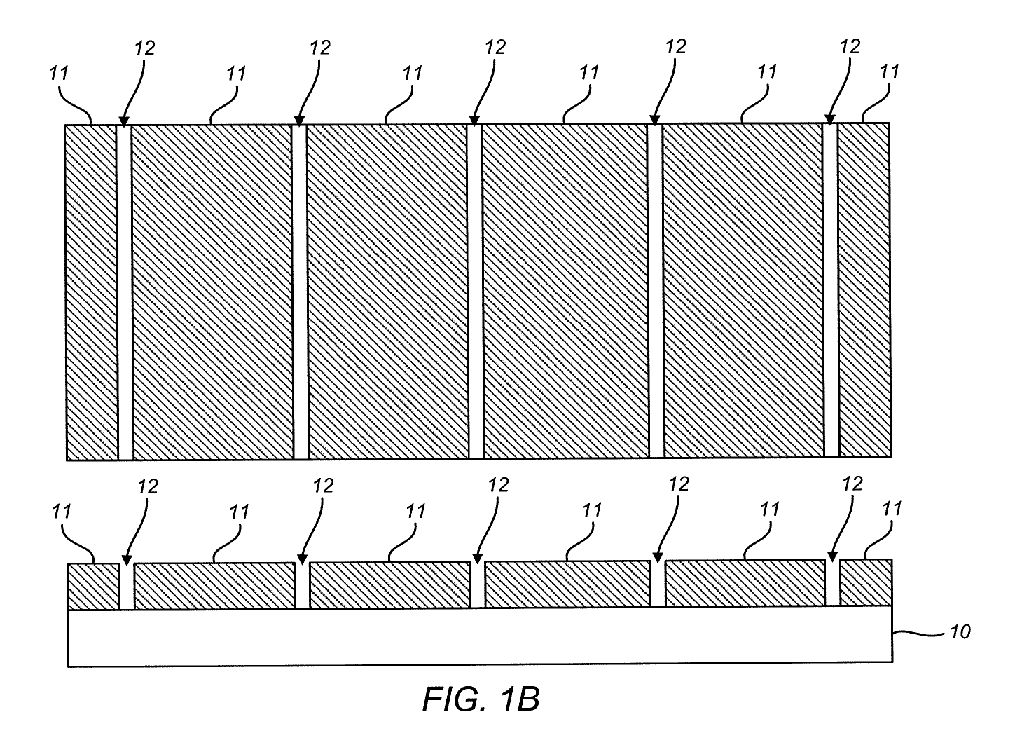

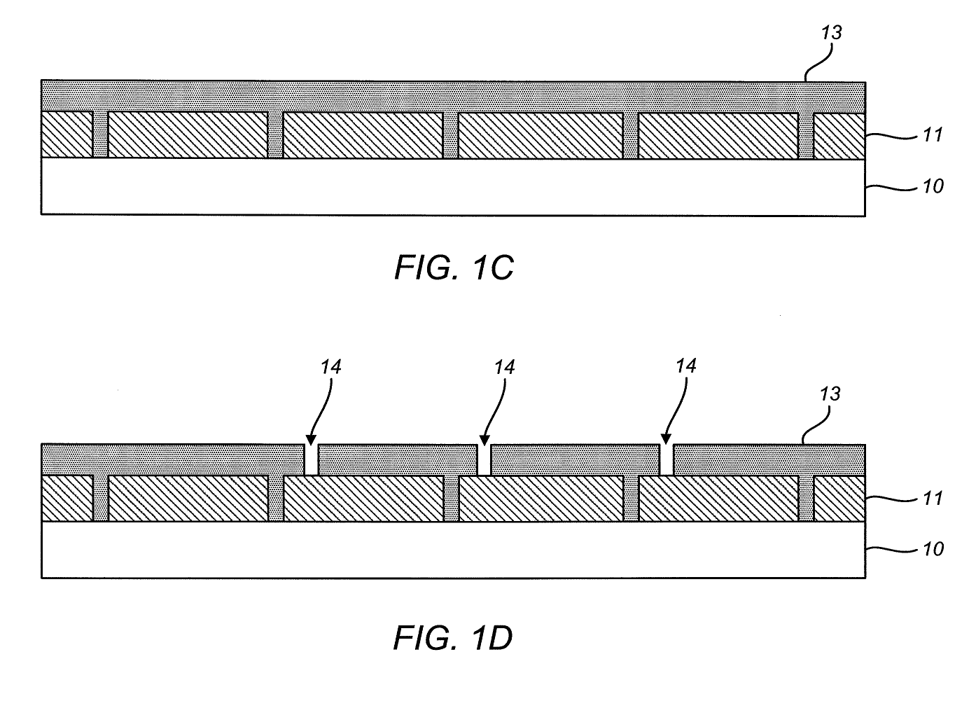

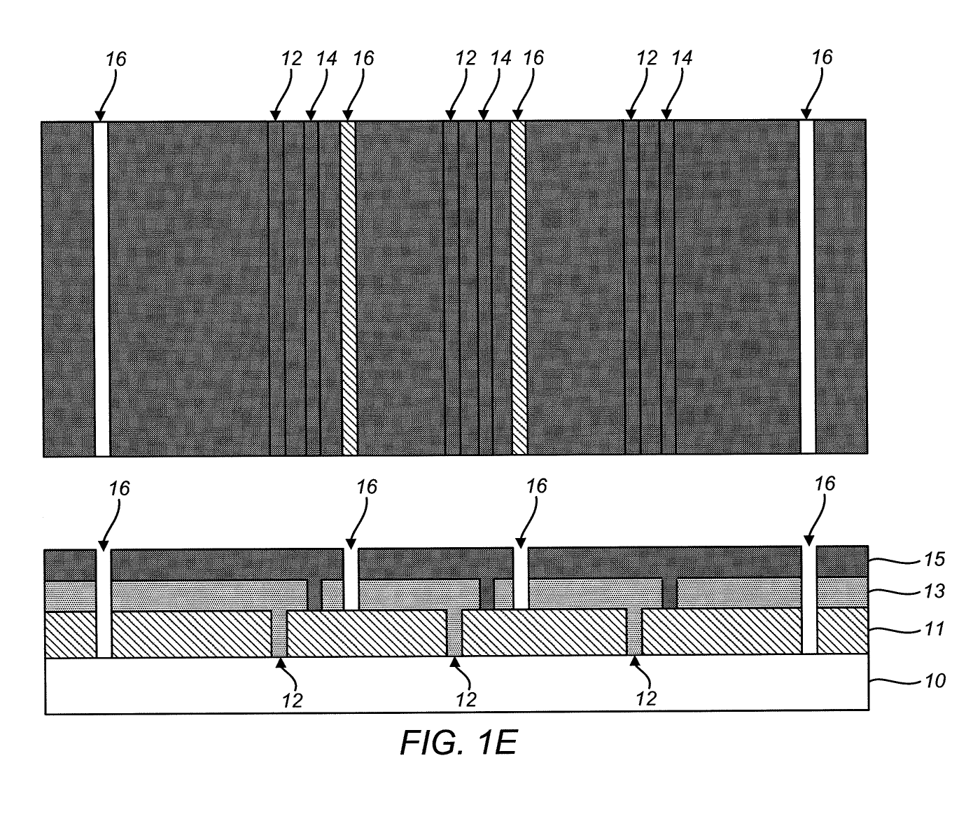

### DETAILED DESCRIPTION

Systems and methods in accordance with various embodiments of the present disclosure relate generally to laser scribing, welding, or patterning of materials, and certain embodiments relate more particularly to systems and methods for positioning or aligning subsequently-formed features relative to previously-formed features on a workpiece. Various embodiments can provide for more accurate alignment of subsequently-formed features with previously-formed features by using dynamic or “real time” alignment control through the use of an imaging device that captures an image(s) of a previously-formed feature(s). These systems and methods can be particularly effective for laser scribing thin-film multi-junction solar cells.

In particular, methods and systems in accordance with many embodiments are provided for scribe alignment. Scribe alignment improves the alignment between laser-scribed lines (or other features, shapes, or patterns) on a workpiece by using an imaging device to locate a previously-formed laser-scribed line and using the image information to control where a subsequently-formed laser-scribed line is located. While many embodiments discussed herein are directed toward laser-scribed lines for purposes of simplicity of explanation, it should be apparent in light of the present disclosure that any appropriate feature or pattern formed into or on a workpiece can take advantage of aspects of the various embodiments. Pulsed lasers are often used to form scribe “spots,” which can overlap to form at least partially continuous features. Alignment processes discussed herein can enable a scribe spot to be positioned relative to a previously formed scribe spot.

A previously-formed laser-scribed line, for example, can be located using what are referred to herein as a “look ahead” and/or a “look behind” process. The previously-formed laser-scribed line can be located just prior to the scribing of the subsequently-formed laser-scribed line, therefore reducing positional errors that may increase as time passes. Therefore, a subsequently laser-scribed line (e.g., P3 line) can be located relative to a previously laser-scribed line (e.g., P1 or P2 line), and follow the form of the previously laser-scribed line, including any curvature, deviations, etc. Scribe alignment allows a subsequently laser-scribed line (e.g., P2 or P3 line) to be aligned as closely as possible to a specified distance relative to a previously laser-scribed line (e.g., P1 or P2 line).

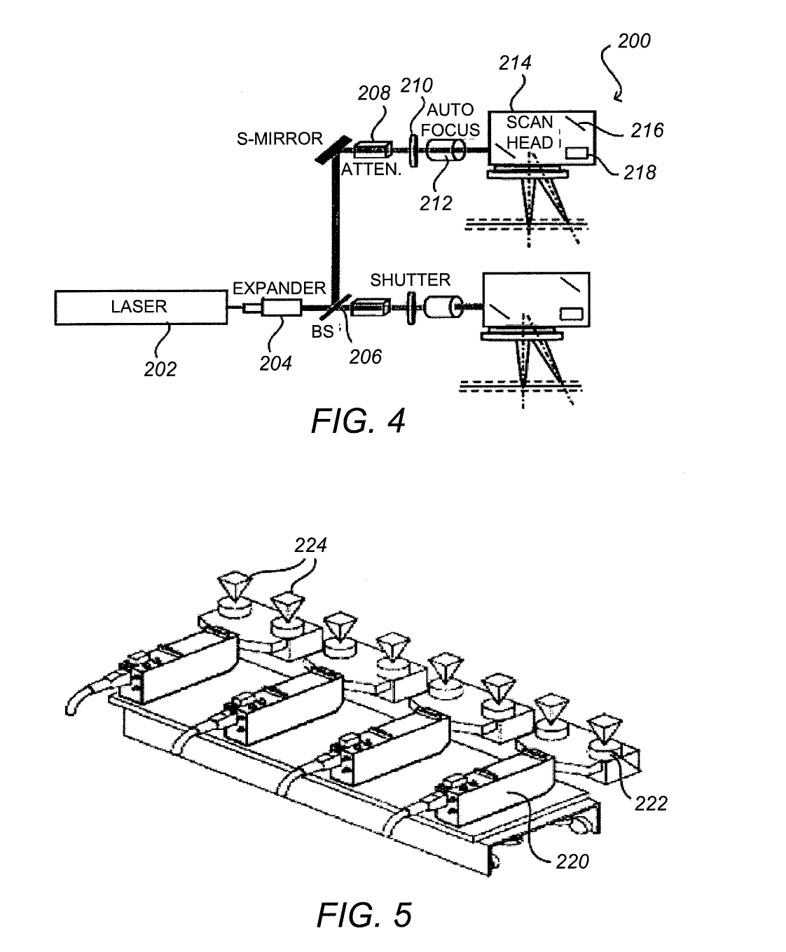

Scribe alignment is particularly well suited to situations where it is desired to minimize the distance between the scribed lines but not critical to maintain the straightness of the scribed lines themselves. One example of such a situation would be to align laser-scribed lines (P1, P2, P3) during solar panel manufacturing as closely as possible in order to minimize the dead zone (i.e. non-active solar-cell area). Ideally, the subsequently laser-scribed line (e.g., P2 or P3 line) would be formed exactly parallel to a straight previously laser-scribed line (e.g., P1 or P2 line), with a minimum amount of space between them. However, the straightness of a laser-scribed line is affected by factors such as stage and mirror optics calibration noise, uncorrected mean errors, process induced geometrical distortions, material property inhomogeneities, and material thickness variations. The relatively large area of a solar panel workpiece also contributes to straightness variations, because slight temperature changes may cause distortion or expansion of the panel or of the laser-scribing system itself. Thermal distortions may become particularly problematic when the area of a solar panel workpiece exceeds 3,000 cm². Scribe alignment can be applied to align a subsequently laser-scribed line (e.g., P2 or P3 line) as closely as possible to a previously laser-scribed line (e.g., P1 or P2 line), without having to maintain the straightness of both lines (e.g., P1 and P2 lines). Furthermore, scribe alignment may also eliminate the need for frequent calibration due to long-term thermal drift of a scanning device, for example, the scan head 214 of FIG. 4.

Laser-Scribing Devices

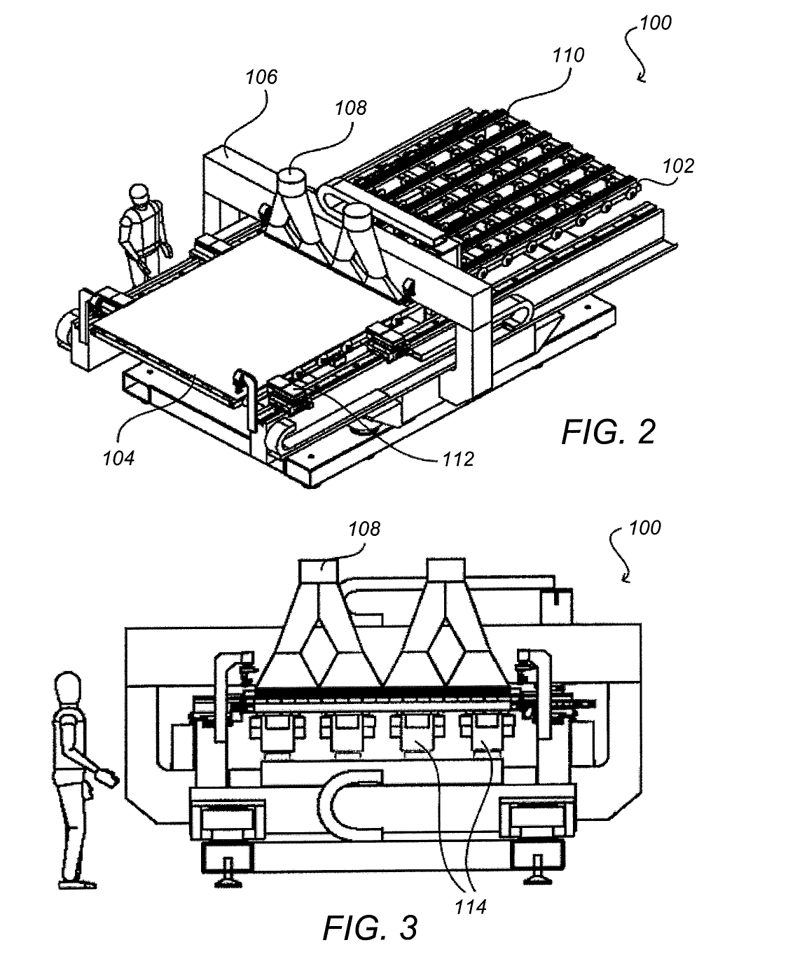

FIG. 2 illustrates a laser-scribing device 100 that can be used in accordance with many embodiments. The laser-scribing device 100 includes a substantially planar bed or stage 102, which will typically be level, for receiving and maneuvering a workpiece 104, such as a substrate having at least one layer deposited thereon. In many embodiments, a workpiece is able to move back and forth along a single directional vector at a rate of up to or greater than 2 m/s. In many embodiments, the workpiece will be aligned to a fixed orientation with the long axis of the workpiece substantially parallel to the motion of the workpiece in the laser-scribing device 100. The alignment can be aided by the use of an imaging device (e.g., a camera) that acquire marks on the workpiece. In the laser-scribing device 100, the lasers (shown in subsequent figures) are positioned beneath the workpiece and opposite a bridge 106 holding part of an exhaust mechanism 108 for extracting material ablated or otherwise removed from the substrate during the scribing process. The workpiece 104 can be loaded onto a first end of the stage 102 with the substrate side down (towards the lasers) and the layered side up (towards the exhaust). The workpiece can be received onto an array of rollers 110, although other bearing- or translation-type objects can be used to receive and translate the workpiece as known in the art. In the laser-scribing device 100, the array of rollers 110 all point in a single direction, along the direction of propagation of the workpiece, such that the workpiece can be moved back and forth in a longitudinal direction relative to the laser assembly. The device can include at least one controllable drive mechanism 112 for controlling a direction and translation velocity of the workpiece 104 on the stage 102. Further description about such a system and its use is provided in co-pending U.S. Provisional Application No. 61/044,390, which is incorporated by reference above.

FIG. 3 illustrates an end view of the laser-scribing device 100, illustrating a series of laser assemblies 114 used to scribe the layers of the workpiece. In the laser-scribing device 100, there are four laser assemblies 114, each including a laser and elements, such as lenses and other optical elements, used to focus or otherwise adjust aspects of the laser. The laser can be any appropriate laser operable to ablate or otherwise scribe at least one layer of the workpiece, such as a pulsed solid-state laser. As can be seen, a portion of the exhaust 108 is positioned opposite each laser assembly relative to the workpiece, in order to effectively exhaust material that is ablated or otherwise removed from the workpiece via the respective laser assembly. Each laser assembly actually produces two effective beams useful for scribing the workpiece. In order to provide the pair of beams, each laser assembly can include at least one beam splitting device.

FIG. 4 illustrates basic elements of a laser assembly 200 that can be used in accordance with many embodiments, although it should be understood that additional or other elements can be used as appropriate. In the laser assembly 200, a single laser 202 generates a beam that is expanded using a beam expander 204 then passed to a beam splitter 206, such as a partially transmissive mirror, half-silvered mirror, prism assembly, etc., to form first and second beam portions. In the laser assembly 200, each beam portion passes through an attenuating element 208 to attenuate the beam portion, adjusting an intensity or strength of the pulses in that portion, and a shutter 210 to control the shape of each pulse of the beam portion. Each beam portion then also passes through an auto-focusing element 212 to focus the beam portion onto a scan head 214. Each scan head 214 includes at least one element capable of adjusting a position of the beam, such as a galvanometer scanner useful as a directional deflection mechanism. In many embodiments, this is a rotatable mirror able to adjust the position of the beam along a latitudinal direction, orthogonal to the movement vector of the workpiece, which can allow for adjustment in the position of the beam relative to the intended scribe position.

In many embodiments, each scan head 214 includes a pair of rotatable mirrors 216, or at least one element capable of adjusting a position of the laser beam in two dimensions (2D). Each scan head can include at least one drive element 218 operable to receive a control signal to adjust a position of the “spot” of the beam within a scan field and relative to the workpiece. In many embodiments, a spot size on the workpiece is on the order of tens of microns within a scan field of approximately 60 mm×60 mm, although various other dimensions are possible. While such an approach allows for improved correction of beam position on the workpiece, it can also allow for the creation of patterns or other non-linear scribe features on the workpiece. Further, the ability to scan the beam in two dimensions means that any pattern can be formed on the workpiece via scribing without having to rotate the workpiece. For example, FIG. 5 illustrates a perspective view of example laser assemblies in accordance with many embodiments. A pulsed beam from each laser 220 is split along two paths, each being directed to a 2D scan head 222. As shown, the use of a 2D scan head 222 results in a substantially square scan field for each beam, represented by a pyramid 224 exiting each scan head 222. By controlling a size and position of the square scan fields relative to the workpiece, the lasers 220 are able to effectively scribe any location on the substrate while making a minimal number of passes over the substrate. If the positions of the scan fields substantially meet or overlap, the entire surface could be scribed in a single pass of the substrate relative to the laser assemblies.

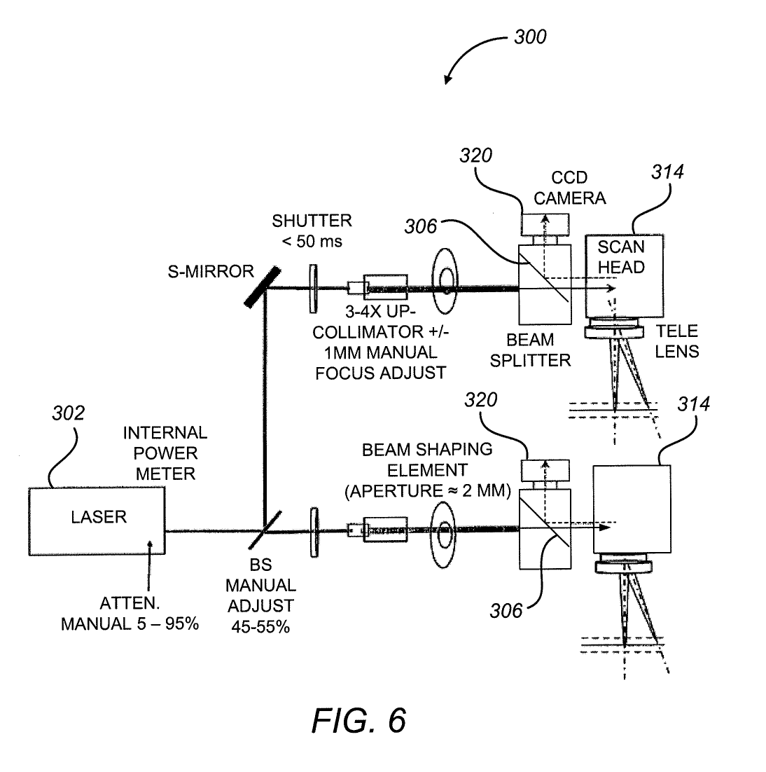

FIG. 6 diagrammatically illustrates a laser assembly 300 in accordance with many embodiments. The laser assembly 300 is similar to the previously discussed laser assembly 200 of FIG. 4, but further includes two imaging devices 320 (e.g., CCD cameras shown) integrated with the laser assembly 300 so that each of the imaging devices 320 can view the workpiece through an associated scanner 314. As shown, each of the imaging devices 320 can be integrated using a dichromatic beam splitter 306 so as provide the imaging device with a view direction that substantially corresponds with the direction along which a separate laser beam portion is provided to each of the scanners 314. As discussed above, although a range of relative positions can be practiced, an imaging device 320 can be integrated with the laser assembly 300 so that the center of its view and the output of the scribing laser 302 point at the same position on a workpiece being targeted by the scanner 314.

Leading Camera Tracking

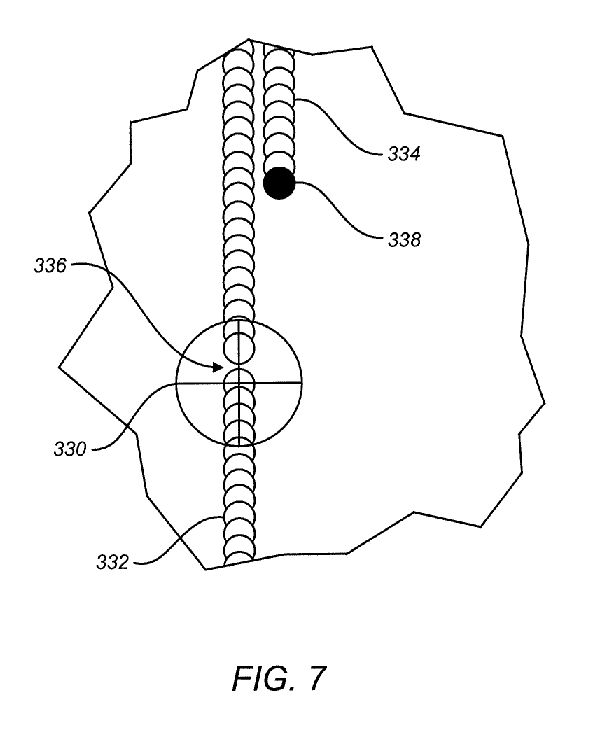

FIG. 7 illustrates the use of leading camera tracking to locate and/or inspect a previously-formed scribe line or other such feature in accordance with many embodiments. During laser scribing of a workpiece, one type of defect that may arise is due to a missing laser shot (i.e., a short), which can be repaired by applying one or more laser shots to the defect location. A imaging device field-of-view 330 (or a region-of-interest) can used to locate and/or inspect a previously-formed scribe line 332 contemporaneously with the formation of an in-progress scribe line 334. The location of defects in the previously formed line 332, such as the defect 336 shown, can be determined by using data from an imaging device (e.g., a charge coupled device (CCD) camera, a CMOS device, etc.) and any other positional data, such as positional data for any scanning device, such as the scanner 314 shown in FIG. 6, and/or positional data for any workpiece translational device. The location(s) of a defect(s) can be stored in memory so that repairs can be made (i.e., a repair laser shot(s) can be applied to the defect(s)).

A variety of approaches can be used provide leading camera tracking. For example, the imaging device field-of-view 330 can have a fixed offset relative to a current laser target location 338. Such a fixed offset can help reduce the amount of reflected light from the laser shots that the imaging device is subjected to. A scanner (such as scanner 314 shown in FIG. 6) can be used to jointly scan both the laser output and the camera view. Separate scanners can be used as well. The workpiece can also be translated relative to the positions of the laser and the camera. Combinations of the above approaches can also be used, such as translating the workpiece and scanning the laser output and the imaging device, either jointly or independently.

One or more imaging devices can be used to provide leading camera tracking. For example, a single imaging device can be used by using different regions-of-interest depending on the scribing direction for the in-progress scribe line 334. As another example, different cameras can be used depending on the scribing direction for the in-progress scribe line, such as using a “leading” imaging device when scribing in a first direction, such as when tracking an existing P1 scribe line while scribing a P2 scribe line, and using a “trailing” imaging device when scribing in a second direction, such as when tracking an existing P2 scribe line while scribing a P3 scribe line.

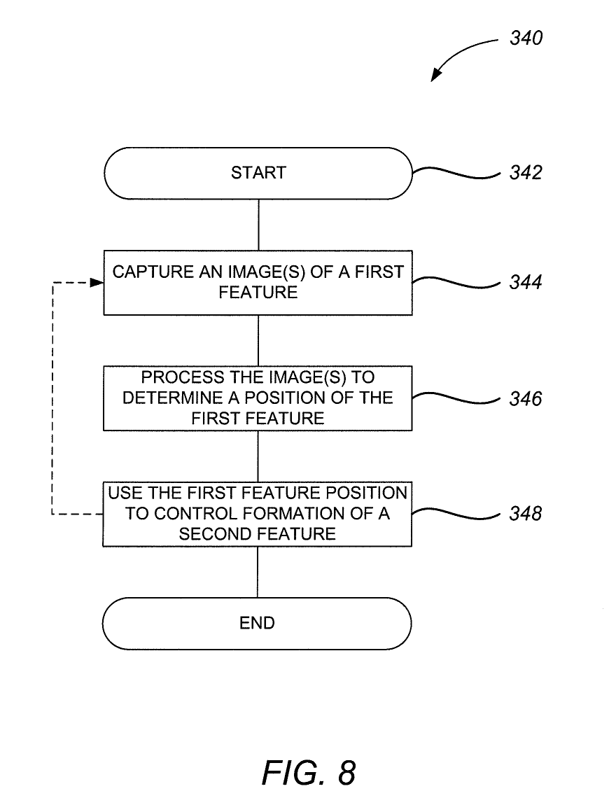

FIG. 8 illustrates a method 340 for using leading camera tracking to laser scribe a workpiece having a first scribed feature in accordance with many embodiments. At the start of the method 340 (i.e., block 342), a workpiece having a previously scribed feature is provided. In block 344, an imaging device, such as a charge coupled device (CCD) camera, is used to capture one or more images along the first scribed feature. In block 346, the image(s) is processed to determine a position of the first scribed feature. In block 348, the first feature position is used to control the formation of a second feature, such as using the first feature position to form the second feature at a controlled distance from the first feature. The actions of blocks 344, 346, and 348 can be repeated along the length of the first feature.

On-The-Fly Inspection and Correction

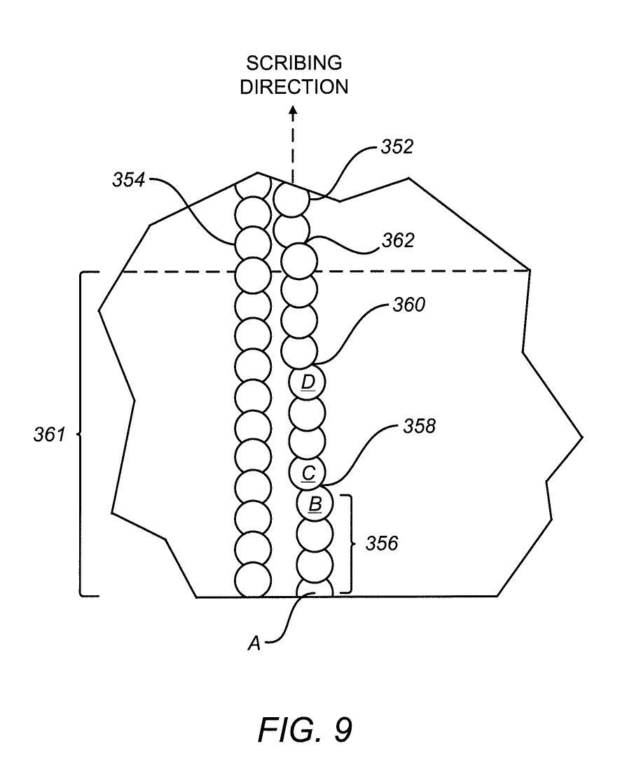

FIG. 9 diagrammatically illustrates the use of “on-the-fly” inspection and forward correction of laser-scribed line position, in accordance with many embodiments. An image capture device, such as a camera or other optical detector, can be positioned and focused so as to capture the position of a newly-formed feature, such as a laser-scribed line or a spot of a laser-scribed line, relative to an adjacent pre-existing feature, such as a pre-existing laser-scribed line. The position for the newly-formed feature can be captured very shortly after the newly-formed feature is formed. The imaging device can capture the relative position of additional newly-formed features as additional new spots of the newly formed scribe line are being formed immediately in advance of the location imaged by the imaging device.

The captured relative positions can be used to adjust the targeted positions for additional new spots of the newly formed scribe line. For example, a new P2 line 352 can be formed next to a pre-existing P1 line 354. The formation of the new P2 line 352 can start at location (A) and sequentially proceed with the formation of subsequent spots, such as spots at locations (B), (C), and (D). When the spot at location (B) is formed, an imaging device, which can lag behind the location where the current spot is being formed by a camera lag distance 356, can be used to capture a relative position between the spot at location (A) and the pre-existing P1 line 354. The captured relative position of location (A) can then be used to adjust the targeted location for subsequently-formed spots. For example, the targeted location for the spot at location (C) can be adjusted by some desired amount based upon the captured relative position so as to result in the formation of features that are located more closely to a desired distance from the pre-existing P1 line 354. The adjustment is shown as occurring at the first position correction location 358. Similar targeted position adjustments can occur, such as at the second position correction location 360, and the third position correction location 362. With a series of corrections, a scribe line, such as new P2 line 352 shown, can be formed in close proximity to an existing scribe line, such a pre-existing P1 line 354 shown. The distance the imaging device measures between the pre-existing line and the new spots or line can be used to send a position correction control signal forward to a laser spot landing position-control system, which can control a laser-scanning device. The actual landing position of the new line can thus be servo-controlled to be as close as desired to the pre-existing line.

The camera lag distance 356 can impact how often adjustments can be made. The greater the lag, the “older” the spots are prior to having their relative positions captured. Preferably, the imaging device captures the relative positions of newly formed features that are less than one meter away from where the additional new spots are being formed. More preferably, the captured relative positions will be less than 100 mm away from where the additional new spots are being formed. Also, the greater the lag, the longer it will take to begin adjusting position. The initial portion of a line will be a given distance away, and it can be desirable to start adjusting the relative separation as quickly as possible.

In some embodiments, an unimportant or otherwise unused portion of the substrate (e.g., a perimeter portion 361 that is subsequently trimmed) can be used to start the process described above. A series of spots or a line segment can be used to make the corrections described above before advancing the new spots or line into an area of the substrate that would be used for power production.

The operation described above can be carried out in a “pulse and detect” mode to minimize the linear distance between the location where the laser spots are being laid down and where the imaging device can be mounted and focused to detect where the new spot positions are located relative to the pre-existing line. When a laser is actively ablating “nearby,” a typical commercially-available imaging device may be “blinded” by the intense light emitted by the ablation process. By pulsing the laser and ablating some material and then waiting a fraction of a second for the intense illumination to subside, the imaging device can image the new spot's landing position. Thus, the linear distance required to make position adjustments can be reduced to a very small amount. In this approach, the laser would be pulsed and a new spot or short line segment would be created. Then the distance between the new spot and the pre-existing line can be measured, the next spot position decided and shot; and the process repeated.

The various methods and systems disclosed herein, such as the above described “on-the-fly” inspection and forward correction of laser-scribed line position, can be used in other fields of endeavor beyond laser scribing of solar panels. For example, embodiments described above with respect to FIG. 9 could be applied to other direct-patterning technologies such as inkjet printing. The methods and system disclosed herein can be used for controlling the formation of a feature relative to an existing feature in general.

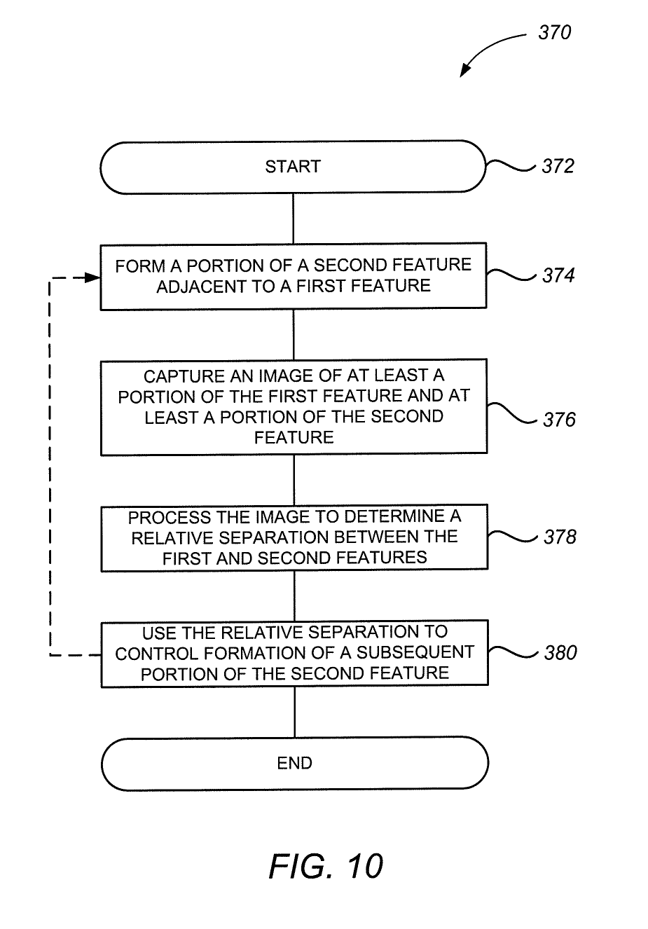

FIG. 10 illustrates a method 370 for using on-the-fly inspection and correction to laser scribe a workpiece having a first scribed feature in accordance with many embodiments. At the start of the method 370 (i.e., block 372), a workpiece having a previously-scribed feature is provided. In block 374, a portion of a second feature is formed adjacent to the first feature. In block 376, an imaging device, such as a CCD camera, is used to capture an image that includes at least a portion of the first and second features. In block 378, the image is processed to determine a relative separation between the first and second features. In block 380, the relative separation is used to control the formation of a subsequent portion of the second feature. The actions of blocks 374, 376, 378, and 380 can be repeated along the length of the first feature.

Closed Loop Control System

Systems and methods in accordance with many embodiments utilize a closed-loop control approach to accurately place a laser-scribed line relative to a previously-formed laser-scribed line. Such a closed loop system can be used to detect the location of a recently-formed feature relative to a earlier-formed feature, such as a recently-formed part of a P2 laser-scribed line relative to an earlier-formed P1 laser-scribed line. By measuring the location of the recently-formed feature shortly after its formation, the location of subsequently-formed features (e.g., subsequent laser ablations) can be adjusted, thereby providing substantial real-time placement control. By reducing the time between measurement and adjustment, potential sources of error may be reduced.

A closed-loop control system may help eliminate sources of error that may exist in open-loop systems. For example, an open-loop system may collect position data for a previously-formed feature during one scribe pass where the x-y table carrying the glass is moving in one direction and the data may be used during the scribing of the next scribe line where the x-y table carrying the glass is moving in the opposite direction. Such an open-loop system may be subject to several sources of error that could be introduced from either x-y stage repeatability or consistency between forward and reverse passes, or from other mechanical and/or optical sub modules.

In addition, an imaging system that is used for both laser scanning and imaging previously-formed features may be based on the use of a telecentric lens to minimize beam positional shift due to glass ride height and thickness variation during the scribing process. However, due to optical and mechanical design requirements, the imaging system and laser-scanning telecentric lenses may have different field-of-view and telecentricity errors. Therefore, depending on beam-deflection angle of the scanner and image-detection angle, governed by the scribe-line pitch, the telecentricity errors in the scanner system could be different; therefore, the detection data acquired by the imaging system and the correction made by scanner may be different. For example, if a P1 line-scribing tool scribes over a thick area of glass when the beam offset is large, the resulting error may be −X μm placement error. In a P2 line-scribing tool, the imaging system sees this −X μm and tells the scanner to adjust by −X μm; however, where the mechanical design and software are common to both tools, the scanner on the P2 tool will also be at a large-deflection angle, over the same thick area of glass. The correction of −X μm is now added to the −X μm caused by the telecentricity error (of this tool) causing a −2X μm shift in the actual position that is marked. This may be repeated for P3 line scribing giving a final shift of −3X μm. The separation between the P1-P3 scribe lines may be 2X μm too large or too small.

A closed-loop control system may provide a number of advantages. For example, a closed-loop system can provide: substantially real-time control of scribe line position detection and placement; reduced scribe placement errors due to telecentricity of optical components and mechanical stack up; monitoring, diagnostics, and/or troubleshooting of laser and related optics; reduced equipment downtime and higher throughput via laser beam power status monitoring; and capability for repair of un-ablated or insufficiently ablated areas.

In many embodiments, a system is provided for the detection of an existing laser-scribed line position for use in correcting the placement of a subsequently-scribed line. The concept is based on using a CCD camera (or other appropriate imaging device) coupled with a laser that is used to scribe (ablate) PV solar-cell thin-film materials. Images can be captured with the CCD camera using an illumination wavelength that is relatively close to the laser wavelength used for scribing in order to minimize chromatic aberration. Image-capture events can be time-controlled and synchronized with laser repetition/frequency and pulse width. The laser pulse frequency for many current solar-cell patterning/scribing processes may range from 10 kHz to 150 kHz (100 usec to 6.67 usec), whereas the maximum pulse width of a typical diode-pumped laser may range from 10 nsec to 100 nsec. Because the width of the ablative laser pulse is typically very short compared to the inverse of laser repetition rate, a time period is provided for image capture that is almost equal to the time period between pulses; therefore, this idle time can be used to illuminate the work field of scribed area for inspection prior to the next laser pulse. Because a CCD capture rate may be low, (i.e., time required to capture one frame is longer than the inverse of laser-scribe frequency), a light strobe and gating control can be used for illumination and image acquisition. A captured image can be processed to extract position data in the period of time before the next image is captured.

In order for a closed-loop control system to process such an image in a short period of time, the control system can employ field programmable gate array (FPGA) based control electronics, for example, which can provide for a relatively fast control system. Captured images can be processed to produce data used to extract one or more scribe-line centroids (or other such mathematical determinations of positional information). The centroid position data can be fed back to the scanning control electronics to deflect and correct the beam path based on the proximity distance with respect to an adjacent previously-scribed line. Two scribe lines can be viewed by the imaging system and the gap in between can be resolved to a few micrometers. Since the variation of scribed-line straightness may be low frequency compared to laser pulsing, the image capture can be performed several millimeters along the scribe length, which allows enough time for imaging device to refresh prior to the next image capture. For example, for a workpiece moving at 2 m/s, a 10 mm interval between image captures gives 10 ms time for image process time. This assumes the scanner is not scanning when performing the correction, which is valid for longitudinal scribe modes of operation.

A closed-loop control system can also be used for latitudinal scribe modes. For latitudinal scribe modes, the scanner may be scanning most of the time except at the junction/transitional points (beginning and end of a scribe line or field). In such a case, an above line position detection system can be used but with a slightly different approach. Images of several detection points along one scribed line can be captured prior to the start of laser scribing. Such capture of images can be repeated for many lines within a scanning field-of-view. The captured image data can then be processed and fed back to the scanner control system to correct the placement of the next line or set of lines for each scribe field. The time required for each scanner to “settle” after a translation between the end of one line, or field, and start of next scribe line or field can be minimized through proper calibration and control. As a scanner may not reliably position scribe spots immediately after a translation due to mechanical vibration and other such factors, it can be desirable to minimize the settling time in order to minimize the overall impact on throughput.

In many embodiments, a photodiode can be used to detect the stability of the laser from pulse to pulse, therefore laser reliability and health status, by measuring the actual laser pulse reflections from the scanning system objective lens or work field. The power and/or energy of each laser pulse can be measured and evaluated against a reference value(s). If the laser pulsing is synchronized to an x/y-encoder used for substrate motion, the landing position of those pulse can also be recorded and used for repair at later time on the same or a different laser-scribing tool.

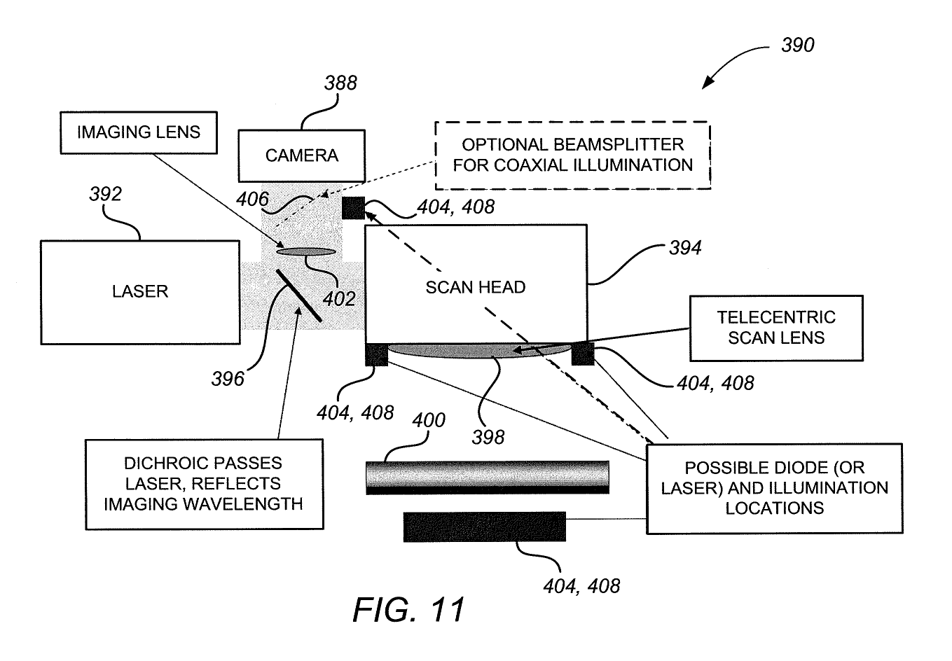

FIG. 11 diagrammatically illustrates the integration of a camera 388 with a laser scanning assembly 390 in accordance with many embodiments. The laser-scanning assembly 390 includes a laser 392 that supplies a laser beam to a scan head 394. The laser beam passes through a dichroic beam splitter 396 on its way to the scan head 394. As described above, the scan head 394 can include at least one element capable of adjusting a position of the laser beam, such as a galvanometer scanner useful as a directional deflection mechanism. The scan head 394 includes a telecentric scan lens 398 that can provide for redirection of a scanned laser beam so as to impinge upon a workpiece 400 in a direction that is substantially normal to the workpiece 400. The laser-scanning assembly 390 includes a camera 388 that is integrated so as to view the workpiece through the scan head. The camera 388 can be used to capture light that is reflected from the workpiece. The reflected light from the workpiece travels through the telecentric lens 398, is redirected by the scan head toward the laser 392, is reflected by the dichroic beam splitter 396, and travels through the imaging lens 402 where the reflected light is received by the camera 388. A photo diode 404, which can be used to measure laser-pulse reflections from the scan lens 398 or from the workpiece 400, can be located in a variety of locations, such as those shown. Where a photodiode 404 is located adjacent to the camera 388, the laser-scanning assembly 390 can include a beam splitter 406 so as to redirect reflected light toward the photodiode. An illumination sources 408 can also be used to supply illumination used for image capture. The illumination sources 408 can be located in the locations shown.

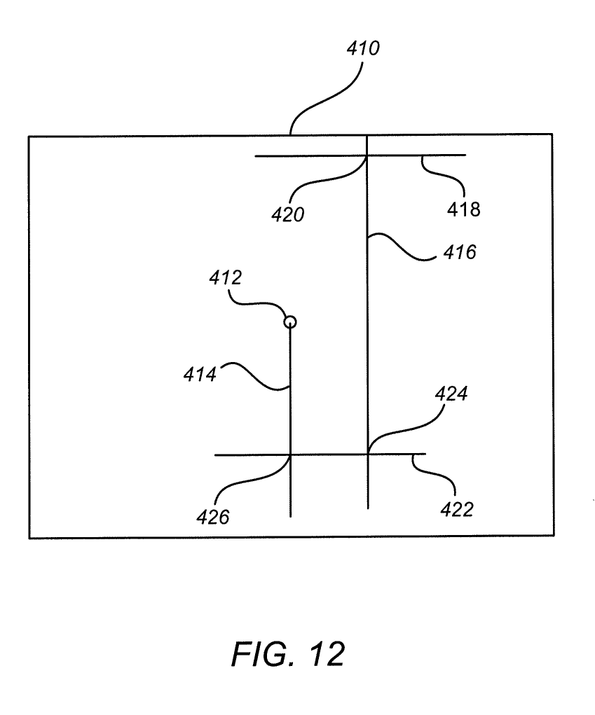

FIG. 12 illustrates a control scheme that can be used in conjunction with an imaging device and a closed-loop control system for scribe alignment in accordance with many embodiments. The imaging device can be variety of devices, such as a charge coupled device (CCD) or a complementary metal-oxide-semiconductor (CMOS) device. The imaging device can be integrated with a laser-scanning assembly (such as shown in FIG. 11) so as to have a field-of-view 410 of a workpiece that can be substantially centered on a laser target location 412 on the workpiece targeted by the scan head. The control scheme can be used to locate a second scribe line 414 relative to a first scribe line 416. As illustrated, the direction of formation for the second scribe line is from bottom to top in the field-of-view 410. A first region-of-interest 418 of the imaging device can be used to acquire a first position 420 of the first scribe line 416 in front of the formation of the second scribe line 414. A second region-of-interest 422 of the imaging device can be used to acquire a second position 424 of the first scribe line and an adjacent position 426 of the second scribe line, which can be used to determine the relative separation between these positions. The first and second positions of the first scribe line, the adjacent position of the second scribe line, and the previously-commanded position of the scan head when the adjacent position of the second scribe line was formed, can all be used by the closed-loop control system to determine what scan head position(s) to command for the subsequent formation of portions of the second scribe line. For example, the first region of interest can be used to acquire a collection of positions of the first scribe line as seen by the imaging device as the scan head is scanning the laser during the formation of the second scribe line. The scan head can then be commanded to scan in accordance with this collection of positions of the first scribe line. The commanded positions of the scan head and the collection of positions of the first scribe line can be saved for use in determining adjustments to how the scan head is commanded relative to the collection of positions of the first scribe line. For example, the relative separation between the first scribe line and the second scribe line acquired by the second region-of-interest of the imaging device can be compared with the corresponding position of the first scribe line acquired earlier when the first region-of-interest was scanned over the corresponding position and the commanded position of the scan head during the formation of the adjacent location of the second scribe line so as to determine an adjustment/correction for the scanning of the laser with respect to the collection of positions acquired by the first region-of-interest (i.e., whether to close or open the relative gap with the previously-formed first scribe line).

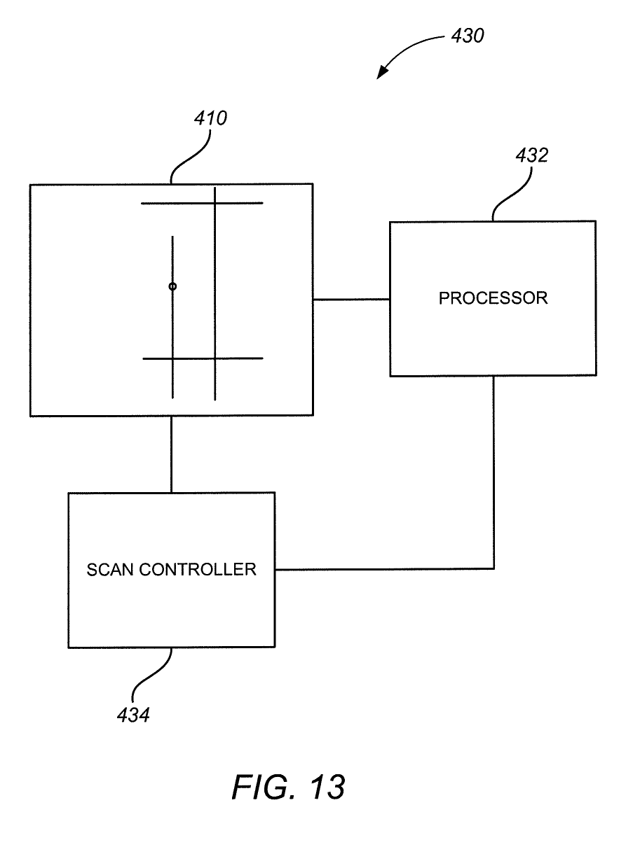

FIG. 13 diagrammatically illustrates a closed-loop control system 430 for scribe alignment, in accordance with many embodiments. The closed-loop control system 430 can use processed image data (such as is discussed with reference to FIG. 12) to control the formation of the second scribe line relative to the previously-formed first scribe line. A processor 432 (and/or a FPGA device) can be used to generate a correction signal that can be supplied to a scan controller 434 for use in correcting subsequent commanded scan head positions. A maximum correction per step can be used to enhance system stability.

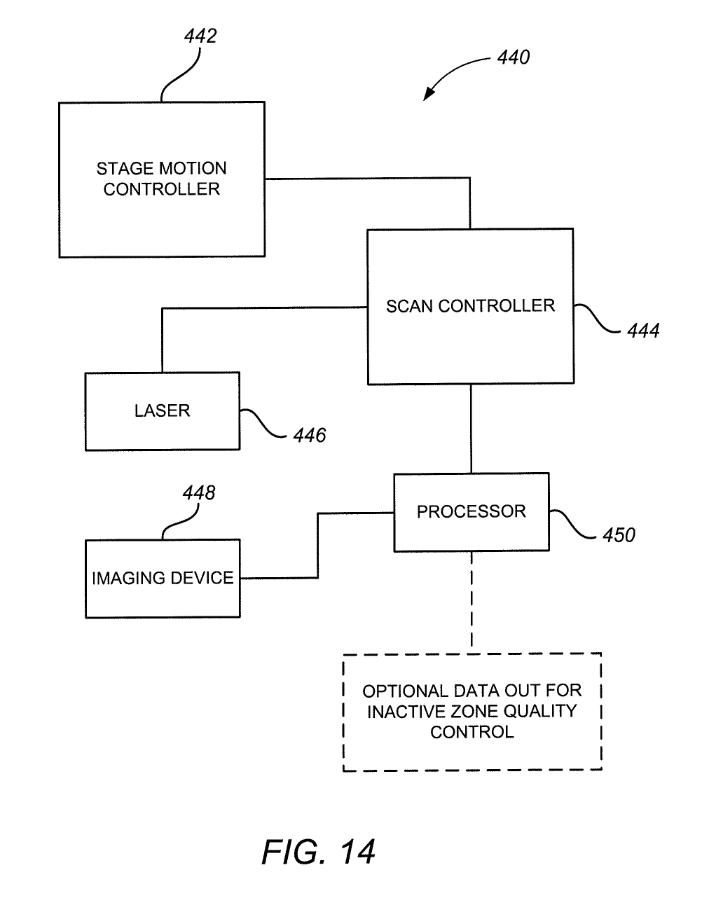

FIG. 14 diagrammatically illustrates signals between components of a scribing system 440, in accordance with many embodiments. A stage motion controller 442 can be used to move a workpiece relative to a scan head. Alternatively, the scan head can be moved relative to the workpiece or a combination of movement of the workpiece and the scan head can be used. The stage motion controller 442 can transfer its positional information to a scan controller 444, including start and stop signals. The scan controller 444 can send fire control signals to a laser 446, including first pulse suppression and off signals. As describe above, an imaging device 448 can supply image-derived data regarding the positions of features on the workpiece to a processor 450. The processor 450 can generate a correction signal that can be supplied to the scan controller 444 for the correction of subsequently commanded scan locations of a scan head used to target output from the laser 446 on the workpiece. At the beginning of the formation of a scribe line relative to a previously-formed scribed line, excess space can be allowed. As the formation of the scribe line progresses, the control system can rapidly close in on a desired line spacing. The system can operate to track lines and maximize active area by keeping P1 close to P2 and P3 close to P2.

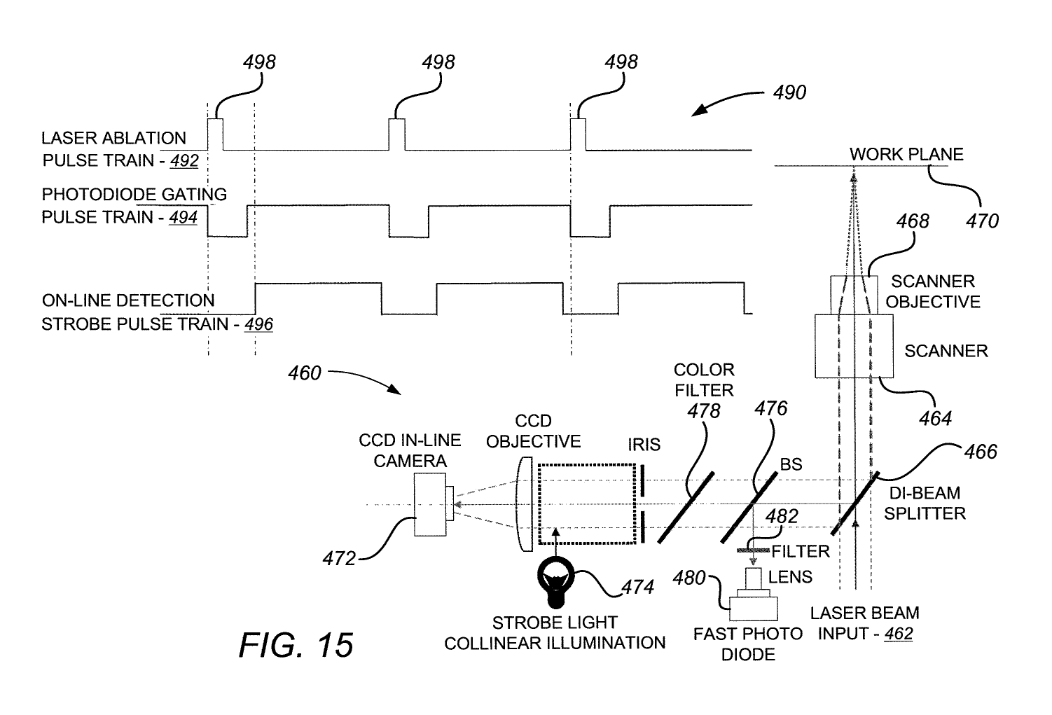

FIG. 15 diagrammatically illustrates an optical detection system 460 and control signals 490 that can be used for scribe alignment, showing relative timing of laser ablation pulses, photodiode timing, and illumination strobe timing, in accordance with many embodiments. The optical detection system 460 can include a laser beam input 462 for supplying laser pulses to a scanner 464. The laser pulses can pass through a dichroic beam 466 splitter on their way to the scanner. The scanner 464 includes a scanner objective lens 468 for redirecting the scanned laser pulse relative to a work plane 470 (i.e., a workpiece). The optical detection system 460 includes a imaging device, such as a CCD camera 472. A strobe light 474 can be used to supply collinear illumination. Alternatively, as discussed above, illumination sources can be located elsewhere in the optical detection system.

Reflections from the work plane 470, such as reflected illumination light, passes through the scanner objective lens 468, and are redirected by the scanner 464 towards the dichroic beam splitter 466. Dichroic beam splitter 466 redirects the reflections towards the imaging device. The reflections pass through the beam splitter 476 and pass through an optional color filter 478. The imaging device receives the reflections and can capture an image of the reflections. A photo diode 480 can be positioned so as to capture laser pulse reflections from the workpiece (located on work plane 470). The photo diode can also capture laser pulse reflections from the scanner objective lens 468. A beam splitter 476 can be used to direct laser pulse reflections to the photo diode. A filter 482 can also be used to filter the reflections measured by the photo diode. In use, a laser pulse (from laser beam input 462) can be directed to scanner 464 for targeting on a work plane 470. A portion of the laser pulse may be reflected by the scanner objective lens 468 back toward the dichroic beam splitter that can be used to redirect the reflections to beam splitter 476 as discussed above. Additionally, reflections from the workpiece can travel to the photo diode by a similar route.

The control signals 490 shown illustrate relative timing between a laser ablation pulse train 492, a photodiode gating pulse train 494, and an on-line detection strobe pulse train 496. As describe above, the laser ablation pulse train 492 can include periodic laser pulses 498 that have a pulse width (i.e., pulse time period) that is relatively short as compared with the time period between pulses. The relative shortness of the pulses provides a period of time between pulses that can be used for image acquisition between when laser pulse reflections are generated. As described above, a photo diode 480 can be used to measure laser-pulse reflections so as to monitor the health of the laser, and to monitor individual pulses so as to store workpiece locations that were subjected to defective laser pulses for possible repair. The photodiode gating pulse train 494 shows that the photodiode gating can be deactivated at the start of a laser pulse 498 (thereby allowing the reflections to reach the photodiode) and activated a period of time after the end of the laser pulse (thereby blocking the reflections from reaching the photodiode) so as to provide a period of time to capture reflections from the laser pulse. The on-line detection strobe pulse train 496 illustrates the activation of the strobe light 474 shortly after the end of the activation of the photodiode gating and the deactivation of the strobe light 474 shortly before the start of the next laser pulse 498. The imaging device can be used to capture an image of workpiece features during the time period that the strobe light 474 is activated. As discussed above, image acquisition can be separated by multiple laser pulses so as to provide additional time for image processing. In such a case, the on-line detection strobe pulse train can be modified so as to keep the strobe light deactivated between laser pulses where no image acquisition is accomplished.

Real-Time Control System

As discussed above, tracking the formation of a feature such as a scribe line can be extremely important for ensuring placement accuracy in applications such as multi-layer thin-film photovoltaic (PV) solar-cell manufacturing. As the desired spacing between patterned (scribed) lines continues to shrink, dead zone spacing becomes smaller in PV solar cells and the fill factor is increased in order to achieve higher output power. Improved laser beam position accuracy control thus is desirable in many applications.

Systems and methods in accordance with various embodiments discussed and suggested herein can detect and correct scribe placement errors using a closed-loop control system. Such an approach may have advantages over other methods, such as some open-loop methods, where information about scribe position obtained at the time of the detection process may get altered, or other sources or errors may be introduced, at the time of correction. Further, some open-loop systems may not utilize in-situ detection and thus cannot easily monitor laser health status and performance to continually optimize associated processes.

Some open-loop approaches mechanically offset a camera vision system from the laser scanning system and optics. Such camera vision systems may be mounted on the same platform as the scanning system or at other appropriate locations. Such systems can be used to provide for direct detection of scribe centroid positions to align features such as P2 to P1, and P3 to P2, etc. Some open-loop systems capture the position of a previously-patterned thin-film layer along one scribing pass, and feed the data back to scanner for the next scribing pass, such as described above. For example, some open loop systems collect position data during one scribing pass, while the xy-table carrying the glass moves in a first direction. The position data can be passed to the scanner such that the scanner can attempt to correct the position of a subsequent scribe line in the next scribing pass, while the xy-table is moving in the opposite direction. This is essentially an “open loop” detection and correction method, which may be subject to errors that may be introduced from either xy-stage repeatability or consistency between forward and reverse passes, other mechanical and optical submodules, etc.

Further, the optical system for systems such as laser deflection and open-loop alignment systems may rely upon a telecentric lens to minimize beam positional shift due to glass ride height and thickness variation during the scribing process, which may be difficult to control during the scribing process. However, due to optical and mechanical design requirements, an open-loop alignment system and a laser-scanning telecentric lenses may have different field-of-view (FOV) and telecentricity errors. Therefore, depending on beam deflection angle of the scanner and the image detection angle, which can be governed by the scribe line pitch, the telecentricity errors in the scanner system may be different. Thus, the detection data from the DSA and the correction made by scanner could be different. For example, if a P1 tool scribes over a thick area of glass when the beam offset is large, the resulting error will be a −X μm placement error. In a P2 tool, the alignment system may detect the −X μm placement error and send instructions to the scanner to adjust by −X μm. However, because the mechanical design and software may be common to both tools, the scanner on the P2 tool may also be at a large deflection angle, over the same thick area of glass. The correction of −X μm is now added to the −X μm caused by the telecentricity error (of this tool), resulting in a −2X μm shift in the actual position that is marked. This is repeated on P3 tool, giving a final shift of −3X μm. The P1-P3 separation distance thus may be 2X μm too large or too small.

Systems and methods in accordance with many embodiments may overcome these and other deficiencies by providing approaches to real-time control of scribe line position detection and placement. Such approaches may provide for reduced scribe placement errors due to telecentricity of optical components and mechanical stack up, for example, and may provide troubleshooting and diagnostics of laser and optical components. Such approaches also may provide lower equipment downtime and higher throughput achieved by laser beam power status monitoring, as well as the capability for future repair of non-ablated and/or partially-ablated areas.

An approach in accordance with many embodiments provides for line position detection and next line placement correction during scribing. In many embodiments, a CCD camera or other appropriate imaging device is coupled with at least one laser that is used to scribe (ablate, etc.) PV solar-cell thin-film materials. In many embodiments, there can be one camera or imaging device per effective laser spot on the workpiece. Images can be captured with the CCD camera(s) using an illumination wavelength that is substantially similar to the laser wavelength used for scribing, in order to minimize chromatic aberration. A time or event for capturing each image can be time-controlled and synchronized with the laser repetition/frequency and pulse width. For example, a laser-pulse frequency for solar-cell patterning/scribing process ranges in many embodiments from about 10 kHz to about 150 kHz (100 usec-6.67 usec), whereas the maximum pulse width of a diode-pumped laser is about 10 nsec-100 nsec. Knowing that the laser pulse width, carrying the ablation energy, is very short compared to the inverse of laser repetition rate, one can assume that the time provided for image capture is almost equal to the pulse period. Thus, this idle time can be used to illuminate the work field of the scribed area for inspection prior to firing of the next laser pulse. Since the capture rate of a CCD camera is relatively low, such that the time required to capture one frame can be longer than the inverse of laser-scribe frequency, a light strobe and gating control can be used for illuminating and imaging acquisition. A captured image can be processed to extract position data until the next capture event takes place.

An line position detection and placement approach in accordance with many embodiments is provided via a closed loop system. A captured image is processed using, for example, fast FPGA-based control electronics. The image can be processed to compute and/or extract scribe line centroid information, or other such information indicative of a position of a feature. The centroid or other such position data can be fed back to the scanning control electronics to deflect, direct, and/or correct the beam path based on the proximity distance with respect to an adjacent previously-scribed line. At least two scribe lines can be viewed by the camera system, and the gap between the lines can be resolved to an appropriate level, such as a few micrometers.

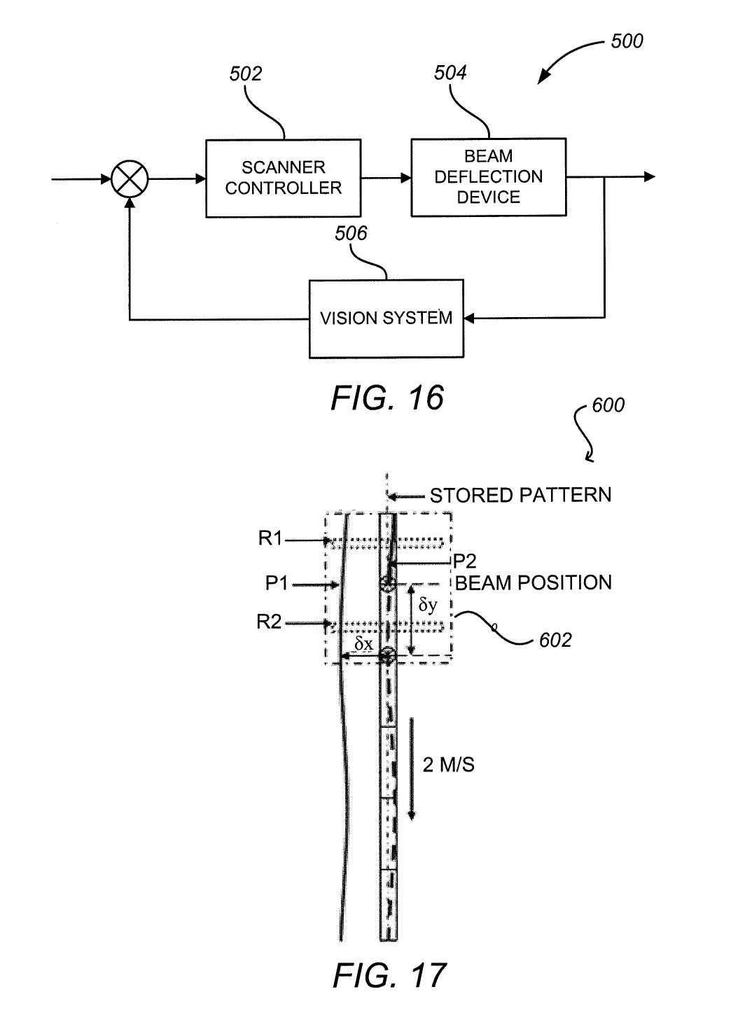

FIG. 16 illustrates a control system 500 wherein the input position is fed to a scanner controller 502, which also receives an indication of the current output position from a vision system 506, such as may include a photodiode or other imaging device as discussed above, and can adjust the beam spot for a new feature by directing a control or other such signal to a beam deflection device 504, able to adjust the position of the laser spot on the workpiece. FIG. 17 illustrates an overview 600 of the beam position relative to a previously scribed feature. As seen in the figure, two regions-of-interest are defined, referred to herein as R1 and R2. These regions are defined within the active or viewable area 602 of a CCD camera, such that the camera can simultaneously capture a position of the P1 and P2 lines (or other such features) as the workpiece is moving relative to the camera. A minimum number of frames (vertical pixels and horizontal pixels) of R1 and R2 can be defined by the camera software to obtain a faster useable capture rate.

For each capture, centroid information can be calculated for P1 and P2. As known in the art, a centroid calculation can be used to determine an effective center point or position of each feature. The results of the centroid calculation can be used as a position for the position of the laser at the positions of the first and second features (P1 and P2), in order to track the position of the P1 line and position (i.e., deflect) the laser to place the P2 line at the desired distance (i.e., separation) from the P1 line using a feedback control loop. Such an approach can include dynamic line displacement due to system vibration during the scribing process as long as the frequency of such displacements is three or more times less than that of the detection cycle. When the scribe pass direction is reversed, the order of R1 and R2 is switched, such as by using the camera software, and the process continues.

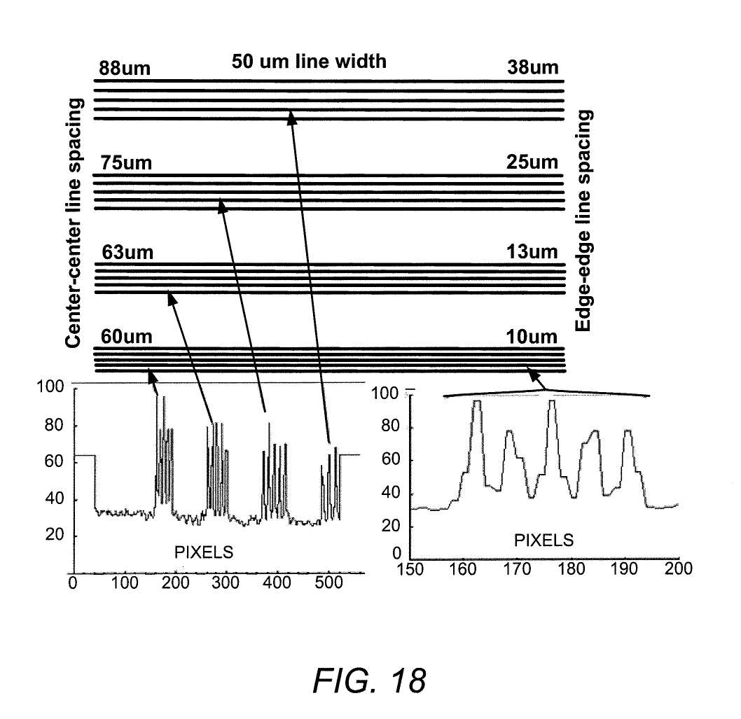

An example using such a process will be discussed with respect to FIG. 18. A series of P1 lines was scribed using a 1064 nm laser on 3 mm thick glass, which was then coated with a P2 TJ layer of about 2 μm in thickness. Images of 50 μm P1 scribe lines of different line-line spacing were captured using an in-situ vision system with a 1X magnification lens and a ⅓″ CCD area camera (640×480 pixels). The center-center line spacing was 60 μm, 63 μm, 75 μm, 88 μm, 106 μm, 113 μm, and 125μm. A red-pointing LED of controlled intensity and including a white diffuser was used to back-illuminate the substrate. The captured images showed dark and bright regions between the lines, indicating that these lines can be distinguished and resolved. Thus, the centroid values for these lines can be determined and used for positioning.

Since a variation in scribed line or feature straightness can be considered to be relatively low frequency, when compared to laser pulse frequency, for example, image capture can be performed several millimeters along the scribe length, which allows enough time for camera to refresh prior to a subsequent capture. In an example for a workpiece moving at 2 m/s, a 10 mm interval between capture times gives 10 ms for image processing time. Such an example assumes that the scanner is not scanning when performing the correction, which is valid for a longitudinal scribe mode of operation, for example.

For a latitudinal scribe mode, the scanner typically will be scanning most of the time, except at the junction/transitional points such as at the beginning and end of a scribe line or field. In such a case, a line position detection approach as described can still be used, but with a slightly different approach. For example, images of several detection points along a scribed line, repeated for many lines within a scanning field-of-view, can be captured prior to the start of actual laser-scribe process. The captured image data can then be processed and fed back to scanner control system to correct the placement of next line or set of lines for each scribe field. The waiting time (required for scanner settling after a jump move) between the end of one line, or field, and start of next scribe line or field can be well controlled, and thus should have relatively low impact on throughput.

An approach in accordance with many embodiments takes advantage of at least one photodiode 480 or other such element to detect the pulse to pulse stability of a laser 462, such as is illustrated in the configuration of FIG. 15, which can help to determine and/or monitor laser reliability and health status by measuring the actual laser pulse reflections from the scanning system objective lens or work field. In this example, the laser beam can reflect off the work plane 470 and be at least partially directed to the CCD camera 472 and to the fast photodiode 480 by the dichroic beam splitter 466 and associated optical elements, such as beam splitter 476. The power and energy of each pulse can be measured and evaluated against a reference value, or some other value that may previously have been determined, measured, or calibrated for the laser. If the pulsing of a laser is synchronized with an xy-encoder of substrate motion, the landing position of those pulses can also be recorded and used for repair at a later time on the same or a different tool.

Work-Piece Defect Detection and Avoidance

In many embodiments, methods and systems for detecting and avoiding workpiece defects during the formation of a laser-scribed line are provided. Workpiece defects may result in the formation of a defective laser-scribed line, for example, when the path of the laser-scribed line encounters the defect. One such workpiece defect that may result in a defective laser-scribed line is a bubble in the TCO layer of the workpiece. In many instances, currently available float glass may have a significant number of bubbles. If the laser tries to scribe through a bubble, a defective laser-scribed line may result. In many embodiments, a workpiece defect is detected and the formation path for a laser-scribed line is altered to avoid the workpiece defect. The avoidance of workpiece defects during the formation of laser-scribed lines may reduce the rate at which defective laser-scribed lines and/or bad cells are formed. The avoidance of workpiece defects during the formation of laser-scribed lines may also allow the use of less expensive float glass.

In many embodiments, methods and systems for detecting and avoiding workpiece defects during the formation of a laser-scribed line can be used to supplement active control alignment between an existing laser-scribed line and a new laser-scribed line. The methods and systems can use an imaging device that is not integrated with the laser optics. The imaging device can be a Time Delay Integration (TDI) camera or a line sensor that runs at a rate that can image a single line of the workpiece that is smaller than the smallest defect of interest (e.g., the smallest TCO layer bubble of interest). For example, in many embodiments a bubble larger than three to five microns may disrupt the scribing of the workpiece. At a two meters per second rate of relative movement, a 400 kHz scan rate may be required to detect a five micron bubble. An optical magnification of three to twenty times may be desirable to be able to resolve the bubble. In many embodiments, current imaging device pixels correspond to about seven to ten microns and it may be beneficial to use at least ten pixels to visualize the bubble. There may be a trade-off in a defect detecting optical system between depth of focus and resolution.

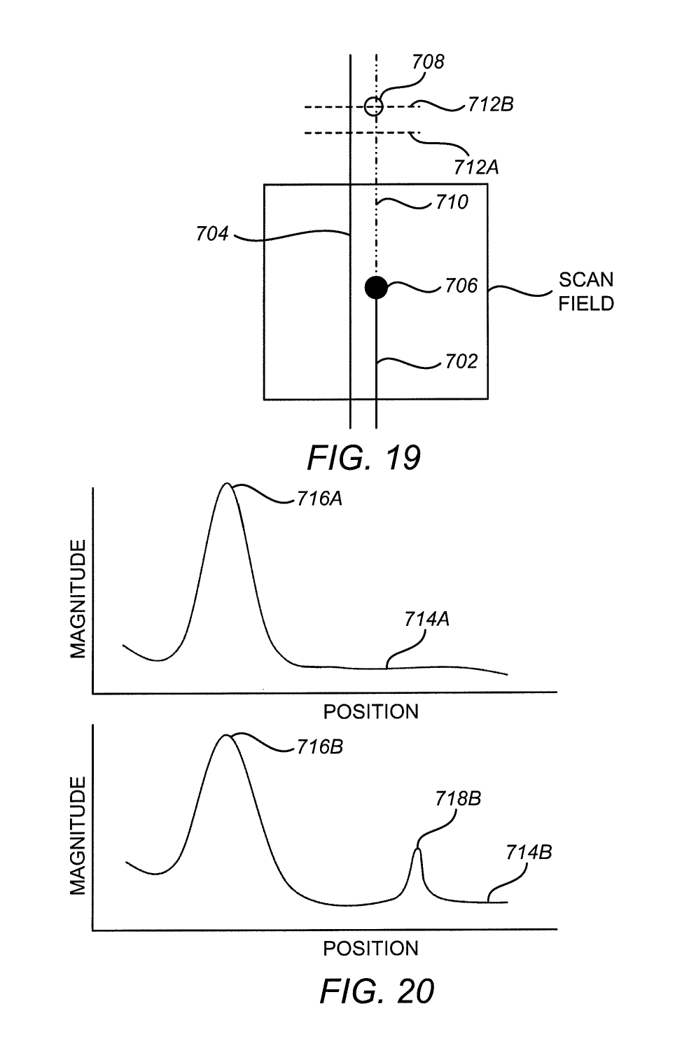

FIG. 19 diagrammatically illustrates the use of an imaging device to detect a workpiece defect in a projected path of a laser-scribed line, in accordance with many embodiments. In this example, a second laser-scribed line 702 is being formed adjacent a previously-formed first laser-scribed line 704. The laser-scribed lines may formed by sequentially directing a series of overlapping laser ablation pulses at the workpiece by sequentially positioning a laser target location 706 along a path of formation. A workpiece defect 708 (e.g., a bubble, etc.) is disposed in the projected formation path 710 of the second laser-scribed line 702. An imaging device is used to capture images of the workpiece along and adjacent to the projected formation path 710. For example, a imaging device comprising a line-sensing device (e.g., a linescan sensor (1 to 8k depending upon desired field-of-view)) can be used to sequentially scan the workpiece along the projected formation path 710 via a series of scan lines 712A, 712B. The captured images can then be processed to detect workpiece defects and/or previously-formed laser-scribed features.

FIG. 20 illustrates example signals generated in response to processing the captured images corresponding to the scan lines 712A, 712B of FIG. 19. The first signal 714A corresponds to scan line 712A and includes a response 716A corresponding to the first laser-scribed line 704. The second signal 714B corresponds to scan line 712B and includes a response 716B corresponding to the first laser-scribed line 704 and a response 718B corresponding to the workpiece defect 708. A series of such signals can be processed to detect workpiece defects located in a projected path of formation of a laser-scribed line. While the above example addressed a situation where the laser-scribed line is being formed adjacent to an existing laser-scribed line, the approach can also be used whenever a laser-scribed line is being formed, for example, when a P1 laser-scribed line is being formed.

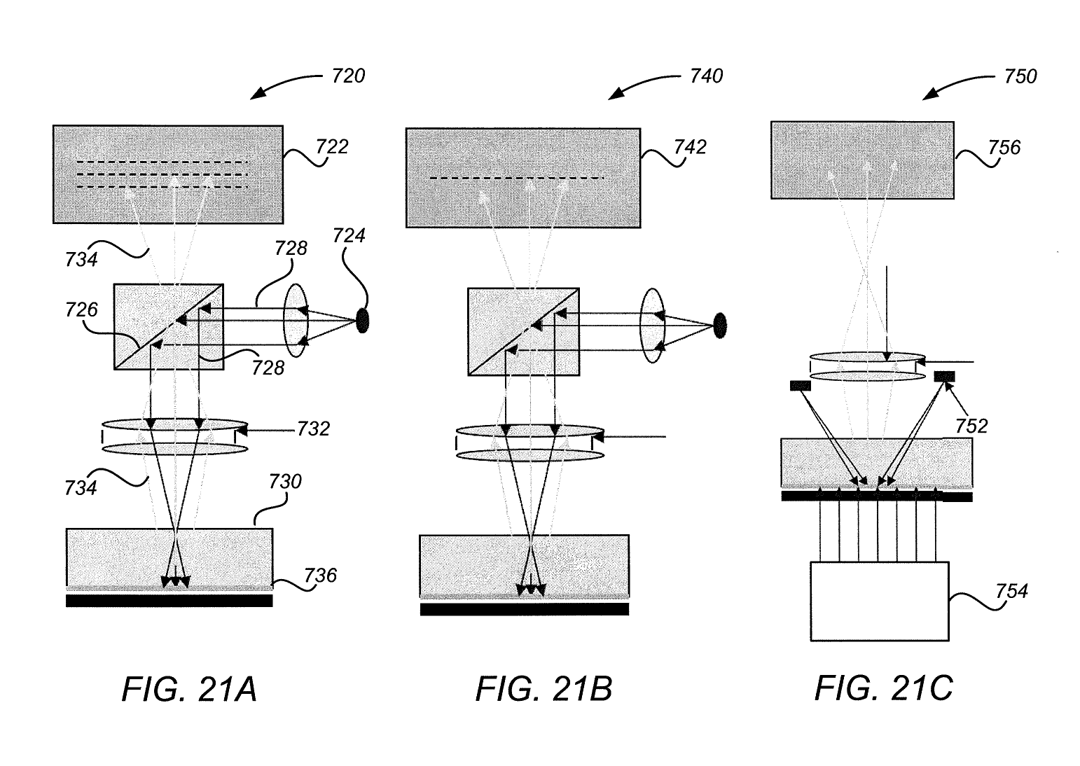

FIGS. 21A, 21B, and 21C diagrammatically illustrate imaging systems that can be used to detect a workpiece defect, in accordance with many embodiments. FIG. 21A illustrates an imaging system 720 that includes a Time Delay and Integration (TDI) imaging device 722. A TDI imaging device, for example, a TDI charge-coupled device (CCD), can be used for inline monitoring and inspection of high-speed moving objects that may be undetectable using a classic CCD device. The TDI imaging device can be synchronized with the rate of movement of the workpiece. The imaging system 720 further includes a workpiece illumination source 724 (e.g., high intensity light emitting diode (LED), a pulsed LED, etc.). A beam splitter 726 directs illumination rays 728 from the illumination source 724 toward the workpiece 730. The illumination rays 728 pass through an imaging lens assembly 732 (e.g., a 3× to 20× magnification imaging lens assembly) and is thereby focused on a portion of the workpiece 730. Illumination rays reflected by the workpiece 730 (i.e., reflected rays 734) passes through the imaging lens assembly 732 and the beam splitter 726 to the TDI imaging device 722. The reflected rays 734 can include rays reflected from lower layer of the workpiece, for example, a TCO layer 736 of the workpiece 730. As discussed above, captured images can be processed to detect workpiece defects and/or previously formed features. For example, captured images can be processed to detect bubbles within the TCO layer 736 of the workpiece 730. FIG. 21B illustrates an imaging system 740 that is similar to the imaging system 720 of FIG. 21A, but uses a line-sensing imaging device 742 (e.g., a line-scan camera) in place of the TDI imaging device 722 of FIG. 21A.

FIG. 21C illustrates an imaging system 750 that illustrates the use of alternate illumination sources. For example, an upper illuminator 752 (e.g., a ring illuminator, an off-axis LED bar, etc.) can be used to direct illumination rays onto the workpiece from above the workpiece. A lower illuminator 754 (e.g., a LED backlight, etc.) can be used to direct illumination rays onto the workpiece from below the workpiece. The imaging system 750 includes an imaging device 756 (e.g., TDI imaging device 722, line-sensing imaging device 742, etc.).

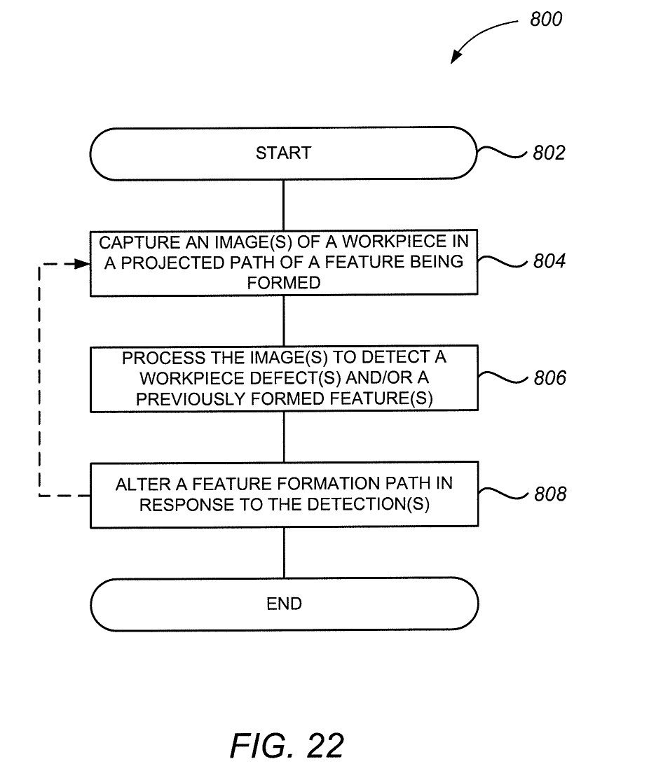

FIG. 22 illustrates a method 800 for detecting and avoiding a workpiece defect during the formation of a laser-scribed line, in accordance with many embodiments. At the start of the method 800 (i.e., at block 802), a workpiece to be scribed along a projected path is provided. In block 804, an imaging device is used to capture one or more images of the workpiece in the projected path of the feature to be formed. In block 806, the one or more images are processed to detect a workpiece defect and/or a previously formed feature. In block 808, the path along which the feature is to be formed can be altered in response to the detection(s) (i.e., detection(s) made in block 806). Blocks 802, 804, 806 can be repeated to monitor for, detect, and avoid a workpiece defect along the projected path of formation of a feature to be formed, such as a to be formed laser-scribed line.

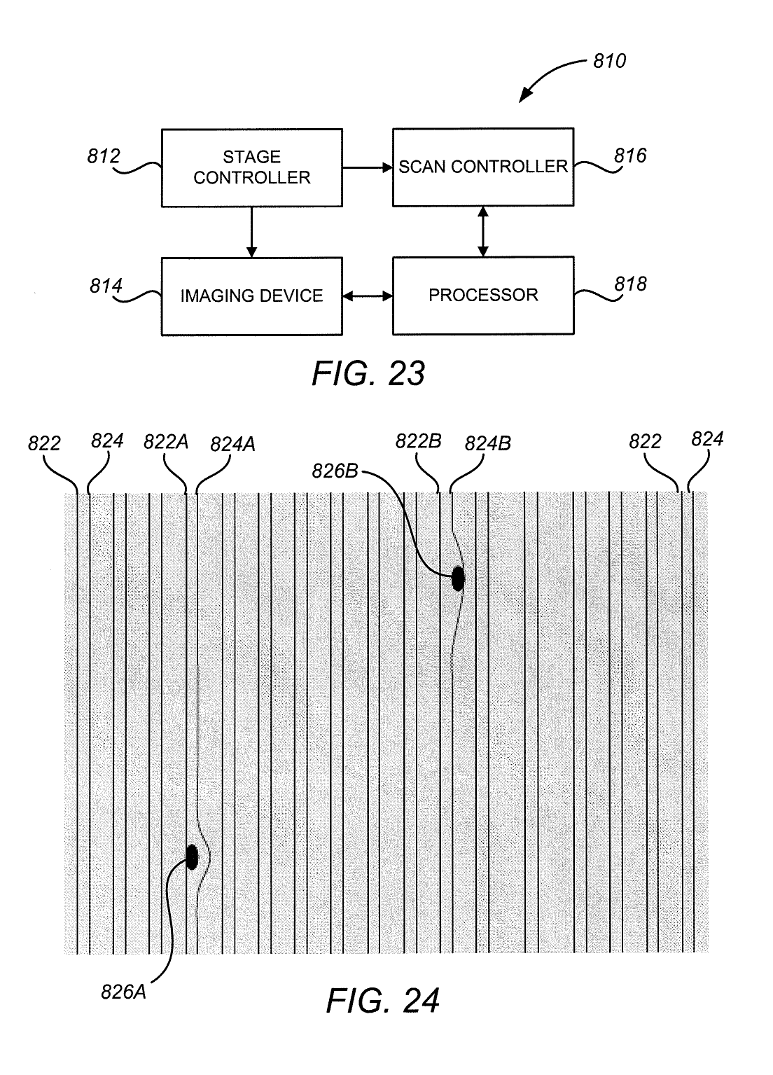

FIG. 23 illustrates a control system 810 for workpiece defect detection and avoidance during laser scribing of a workpiece, in accordance with many embodiments. In the control system 810, a stage controller 812 sends position signals or triggers to an imaging device 814 used to monitor for workpiece defects and to a scan controller 816 used to control the position of laser ablations used to form a laser-scribed line. Image data from the imaging device 814 is sent to a processor 818, where it is processed to detect a workpiece defect(s) and/or a previously formed feature(s). In many embodiments, the processor 818 comprises a field-programmable gate array (FPGA) or other fast video processor. The processor 818 identifies one or more workpiece defects and determines scribe-path corrections to avoid an identified defect(s). The processor 818 communicates the determined scribe-path corrections to the scan controller 816 for use in scribing the feature so as to avoid the identified defect(s).

FIG. 24 illustrates two example laser-scribed line paths that can be used to avoid workpiece defects, in accordance with many embodiments. FIG. 24 illustrates a workpiece having a number of adjacent laser-scribed lines 822, 824. A defect 826A is located adjacent to laser-scribed lines 822A, 824A. As illustrated, laser-scribed line 822A contacts the defect 826A, but the formation path for the laser-scribed line 824A was altered in the region of the defect 826A so as to avoid the defect. As a result, isolation between the laser-scribed lines 822A, 824A is maintained despite the presence of the defect 826A. A similar situation exists with respect to a defect 826B located adjacent to laser-scribed lines 822B, 824B, except that the laser-scribed line 824B contacts the defect 826B while the laser-scribed line 822B does not contact the defect 826B. As a result, isolation between laser-scribed lines 822B, 824B is maintained despite the presence of the defect 826B.

It is understood that the examples and embodiments described herein are for illustrative purposes and that various modifications or changes in light thereof will be suggested to persons skilled in the art and are to be included within the spirit and purview of this application and the scope of the appended claims. Numerous different combinations are possible, and such combinations are considered to be part of the present invention.

What is claimed is:

1. A method for laser scribing a workpiece using a laser-scribing device, the workpiece having a first scribed feature, the method comprising:
using an image-capture device to capture sequential images along the first feature;
processing at least one of the images so as to determine a position of the first feature; and
using the first feature position to control the formation of a second scribed feature at a controlled distance from the first feature, the formation of at least a part of the second feature being accomplished before the capture of at least one of the images.

2. The method of claim 1, further comprising processing a plurality of the images so as to detect inadequately ablated locations.

3. The method of claim 1, further comprising processing a plurality of the images so as to generate positional data for the first feature and storing the positional data in a memory device.

4. The method of claim 3, wherein a region-of-interest of the image-capture device is used in the processing of the plurality of the images.

5. A method for laser scribing a workpiece using a laser-scribing device, the workpiece having a first scribed feature, the method comprising:
forming a first length of a second scribed feature adjacent to the first feature;
using an image-capture device to capture a first image that includes at least a portion of the first feature and at least a portion of the first length of the second feature;
processing the first image so as to determine a first relative separation between the first feature and the second feature; and
using the first relative separation to align the output from the laser-scribing device in order to form a second length of the second feature within a smaller deviation from a controlled distance from the first feature than for the first length of the second feature.

6. The method of claim 5, further comprising:
using the image-capture device to capture a second image that includes at least a portion of the first feature and at least a portion of the second length of the second feature;
processing the second image so as to determine a second relative separation between the first feature and the second feature; and
using the second relative separation to align the output from the laser-scribing device in order to form a third length of the second feature within a smaller deviation from a controlled distance from the first feature than for the second length of the second feature.

7. The method of claim 6, further comprising:
using the image-capture device to capture a third image that includes at least a portion of the first feature and at least a portion of the third length of the second feature;
processing the third image so as to determine a third relative separation between the first feature and the second feature; and
using the third relative separation to align the output from the laser-scribing device in order to form a fourth length of the second feature within a smaller deviation from a controlled distance from the first feature than for the third length of the second feature.

8. The method of claim 7, wherein the first, second, and third lengths are contiguous.

9. The method of claim 8, wherein the first length, the second length, and the third length are disposed within a perimeter portion of the workpiece.

10. A system for laser scribing a workpiece having a first scribed feature and a partially-formed second scribed feature, the system comprising:
a laser operable to generate output able to remove material from the workpiece;
a scanning device operable to control a position of the output from the laser relative to the workpiece;
an imaging device having a predetermined orientation relative to the scanning device, the imaging device capturing an image between laser pulses and outputting image data in response thereto, the image including at least a portion of the first feature and at least a portion of the second feature; and
a control device coupled with the scanning device and the imaging device, the control device being adapted so as to process the image data so as to generate a positional correction for the formation of a subsequent portion of a second feature relative to the first feature.

11. The system of claim 10, wherein the control device is further adapted to output the positional correction.

12. The system of claim 11, wherein the scanning device includes a scan controller adapted to receive the positional correction from the control device.

13. The system of claim 10, wherein the control device comprises a field-programmable gate array (FPGA).

14. The system of claim 10, wherein the control device comprises a processor and a computer-readable medium that includes instructions that when executed by the processor causes the control device to accomplish said processing of the image data.

15. The system of claim 10, further comprising a laser-pulse reflection measuring device.

16. The system of claim 15, wherein the measuring device comprises a photodiode.

17. The system of claim 10, wherein the control device is further adapted to process the image data so as to generate data indicative of insufficiently ablated features.

18. A method for patterning a workpiece, comprising:
forming a first feature on a workpiece;
forming a first portion of a second feature on the workpiece;
generating position data for the first feature and the first portion of the second feature by using at least two regions in a viewable area of an imaging device;
determining a separation distance between the first feature and the first portion of the second feature by using position data from at least one of the two regions; and
forming a second portion of the second feature by using the separation distance to control a position of the second portion of the second feature relative to the first feature.

19. The method of claim 18, wherein the determining a separation distance comprises determining a centroid position for each of the first and second features.

20. A method for forming a laser-scribed line within a solar-cell assembly having a defect, the method comprising:
using an imaging device to capture one or more images of the assembly, the one or more images including a portion of the assembly located in a formation path for the laser-scribed line;
processing the one or more images to detect a defect of the assembly; and
altering the formation path of the laser-scribed line to prevent the defect from interfering with the formation of the laser-scribed line.

21. The method of claim 20, wherein the imaging device comprises a Time Delay and Integration (TDI) device.

22. The method of claim 20, wherein the imaging device comprises a line-sensing device.

23. The method of claim 20, further comprising illuminating the assembly during image capture.

24. The method of claim 20, further comprising processing the one or more images to detect a position of an adjacent laser-scribed line.

25. The method of claim 24, wherein said altering the formation path is accomplished to maintain at least one of a separation distance between the laser-scribed line and the defect or a separation distance between the adjacent laser-scribed line and the defect.

26. A system for laser scribing a solar-cell assembly having a defect, the system comprising:
a laser operable to generate output able to remove material from the assembly;
a scanning device operable to control a position of the output from the laser relative to the assembly;
an imaging device for capturing one or more images of a portion of the assembly located in a projected formation path for a laser-scribed line and outputting image data in response thereto; and
a processor coupled with the imaging device and the scanning device, the processor comprising a tangible medium comprising instructions that when executed cause the processor to:
process the image data to detect a defect of the assembly, and
alter the formation path for the laser-scribed line to prevent the defect from interfering with the formation of the laser-scribed line.

27. The system of claim 26, wherein the imaging device comprises at least one of a Time Delay and Integration (TDI) device or a line-sensing device.

28. The system of claim 26, further comprising an illumination device to illuminate the assembly during image capture.

29. The system of claim 26, wherein the tangible medium further comprises instructions that when executed cause the processor to:
process the image data to detect a position of an adjacent laser-scribed line; and
alter the formation path for the laser-scribed line to maintain at least one of a separation distance between the laser-scribed line and the defect or a separation distance between the adjacent laser-scribed line and the defect.
